(19) United States
(12) Patent Application Publication
(10) Pub. No.: US 2026/0303176 A1
(43) Pub. Date: Oct. 1, 2026

(54) METHODS, ARCHITECTURES, APPARATUSES AND SYSTEMS FOR DOPPLERPRECODING AND DOPPLER COMPENSATION

(71) Applicant: InterDigital Patent Holdings, Inc., Wilmington, DE (US)

(72) Inventors: Javier Lorca Hernando, Madrid (ES); Patrick Svedman, Stockholm (SE); Arman Shojaeifard, London (GB); Ahmet Serdar Tan, London (GB); Kyle Pan, Saint James, NY (US); Allan Tsai, Boonton, NJ (US)

(21) Appl. No.: 18/996,489

(22) PCT Filed: Jul. 18, 2023
(86) PCT No.: PCT/US2023/028039

§ 371 Date: Jan. 17, 2025

Related U.S. Application Data
(60) Provisional application No. 63/390,466, filed on Jul. 19, 2022.

(51) Int. Cl. H04B 7/06; H04L 5/00

(52) U.S. Cl. CPC H04B 7/063; H04L 5/0048

(57) ABSTRACT

Procedures, methods, architectures, apparatuses, systems, devices, and computer program products implemented by a first wireless communication device receiving, from a second wireless communication device, first information indicating a tracking reference signal (TRS) resource set and configuration information for doppler precoding of the TRS resource set; receiving, from the second wireless communication device, a TRS from among the indicated TRS resource set; determining an amount of doppler spread based on (1) the received TRS and (2) the configuration information for doppler precoding of the TRS resource set; sending, to the second wireless communication device, second information indicating the amount of doppler spread; and sending data and control signals to the second wireless communication device.

### CROSS-REFERENCE TO RELATED APPLICATIONS

This application claims the benefit of U.S. Provisional Patent Application No. 63/390,466 filed Jul. 19, 2022, which is incorporated herein by reference.

### TECHNICAL FIELD

The present disclosure is generally directed to the fields of communications, software and encoding, including, for example, to methods, architectures, apparatuses, systems directed for Doppler precoding and Doppler compensation.

### SUMMARY

The following disclosure describes changes in downlink control and data signals and uplink reporting of feedback information to facilitate Doppler mitigation in single-transmit-receive point (TRP) and multi-TRP scenarios. The gNode-B (gNB), based on a measured or reported indication of a wireless transmit/receive unit (WTRU) speed and any current or previous feedback about Doppler, performs an analysis of the Doppler shift components in the uplink channel matrix over an observation window. The gNB performs Doppler compensation of uplink received signals based on the Doppler shift components, and Doppler precoding of the downlink data signals and TRS resources contained in a TRS resource set assigned to the users. The WTRU measures the Doppler at the TRS signals contained in the assigned TRS resource set, and reports back an indication to the gNB to refine Doppler precoding.

Methods and procedures for Doppler precoding and compensation in single-TRP and multi-TRP scenarios, may comprise any of the following actions:
obtaining an initial duration of a Doppler observation window and an initial TRS resource set from a transmitting Base Station, e.g., from higher-layer signaling;
determining a Doppler information, e.g., a user's speed v and a Doppler indication R from said Base Station;
updating by the Base Station the Doppler observation window and the TRS resource set based on the Doppler information, e.g., the user's speed above a first threshold T₁ and the Doppler R above a second threshold T₂;
estimating by the Base Station the Doppler shift components characterizing the signals over the duration of the Doppler observation window;
performing Doppler precoding of the TRS resource set and the control and data signals by the Base Station based on the estimated Doppler shift components, and transmitting TRS and control and data signals to the User Equipment; and
sending Doppler signaling information by the Base Station containing, e.g., the TRS resource set or a Doppler indication to the User Equipment.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example WTRU that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a definition of tracking reference signal (TRS) signals in 5G NR;

FIG. 3 illustrates a high-speed train (HST) scenario in 3GPP Release 16 showing single-frequency network (SFN) transmission;

FIG. 4 illustrates a NR Rel-17 simplified HST-SFN transmission model;

FIG. 5 illustrates a multi-TRP exemplary scenario with ultra-massive multiple input multiple output (UM-MIMO) characterized by a moving device with velocity v and non line-of-sight (NLOS);

FIG. 6 illustrates examples of TRS resource sets;

FIG. 7 illustrates processing steps for Doppler precoding of physical downlink shared channel (PDSCH) and TRS signals, and Doppler compensation of physical uplink shared channel (PUSCH), physical uplink control channel (PUCCH) and sounding reference signal (SRS) signals;

FIG. 8 illustrates multi-TRP scenario with joint or SFN transmission to/from a WTRU showing success (green) or failure (red) of Doppler precoding for different beams;

FIG. 9 illustrates closed-loop interaction for Doppler precoding and compensation of uplink (UL) and downlink (DL) signals;

FIG. 10 illustrates an exemplary procedure for the transmission of signals based on Doppler precoding.

FIG. 11 illustrates an exemplary alternative procedure for the transmission of signals based on Doppler precoding;

FIG. 12 illustrates an exemplary procedure for the reception of signals based on Doppler compensation;

FIG. 13 illustrates an alternative exemplary procedure for the reception of signals based on Doppler compensation;

FIG. 14 illustrates an exemplary procedure for the transmission and reception of signals by a User Equipment based on Doppler information;

FIG. 14 illustrates an exemplary procedure implemented by a wireless communication device transmitting signals to a second wireless communication device for the transmission and reception of signals based on Doppler information;

FIG. 15 illustrates another exemplary procedure implemented by a wireless communication device transmitting signals to a second wireless communication device for the transmission and reception of signals based on Doppler information;

FIG. 16 illustrates a further exemplary procedure implemented by a wireless communication device transmitting signals to a second wireless communication device for the transmission and reception of signals based on Doppler information; and

FIG. 17 illustrates a further exemplary procedure implemented by a wireless communication device transmitting signals to a second wireless communication device for the transmission and reception of signals based on Doppler information.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

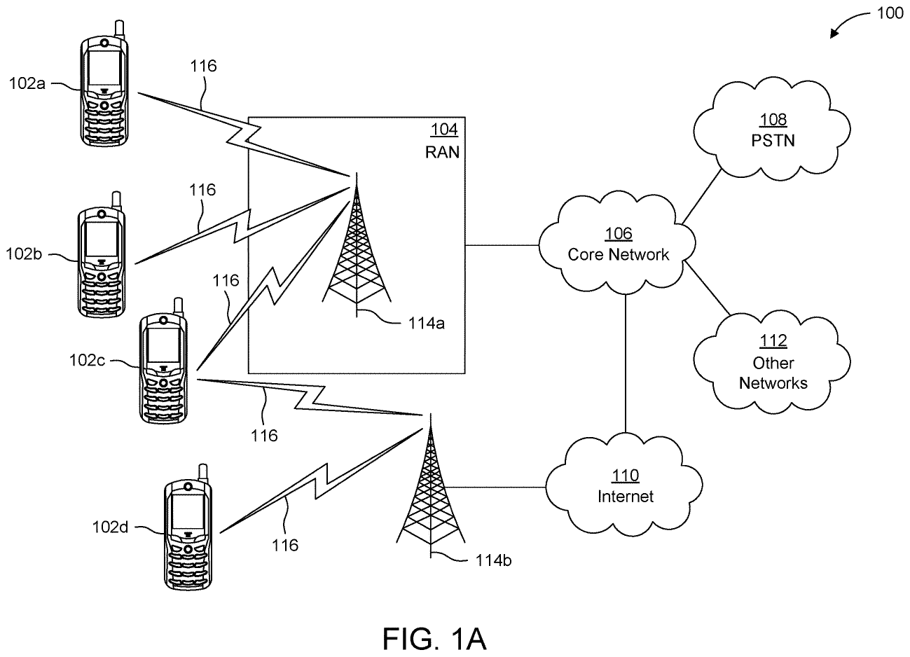

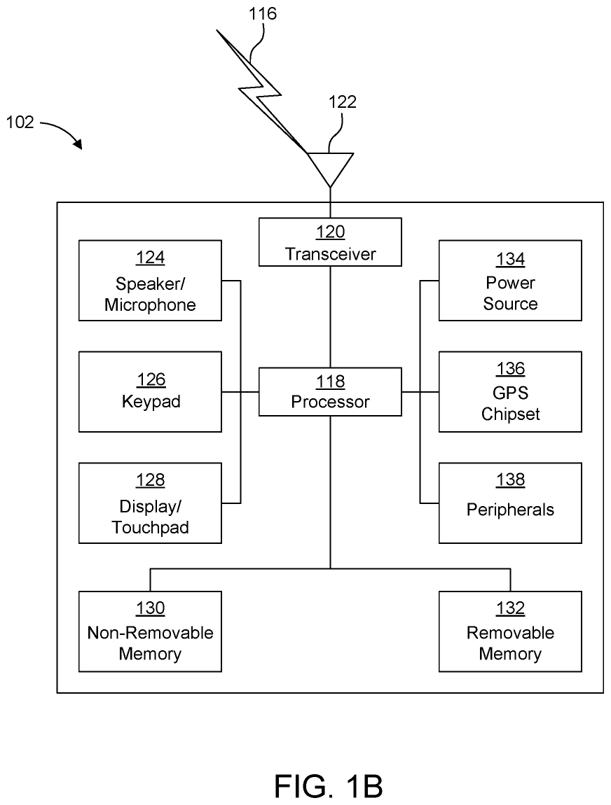

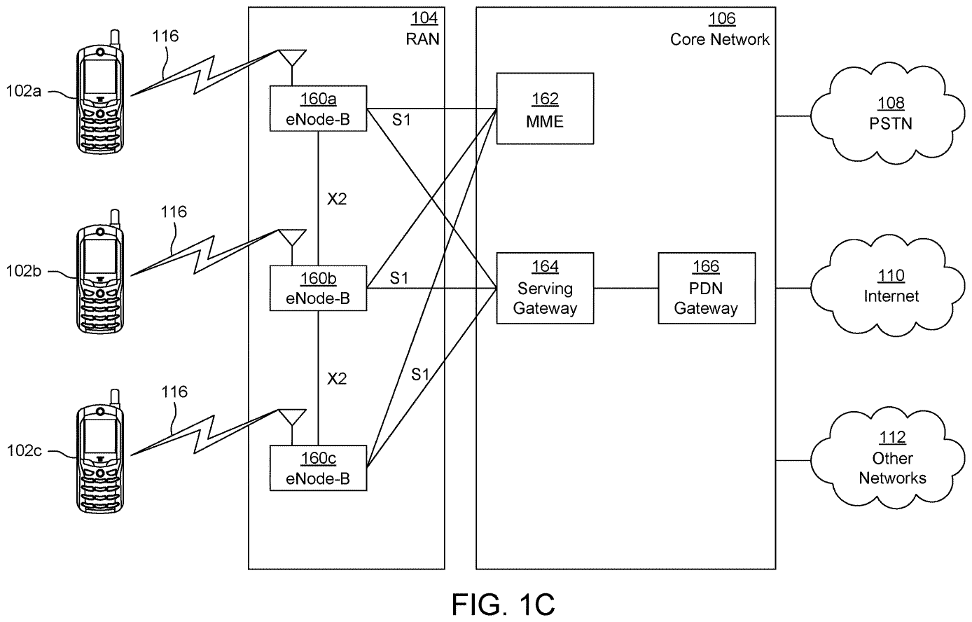

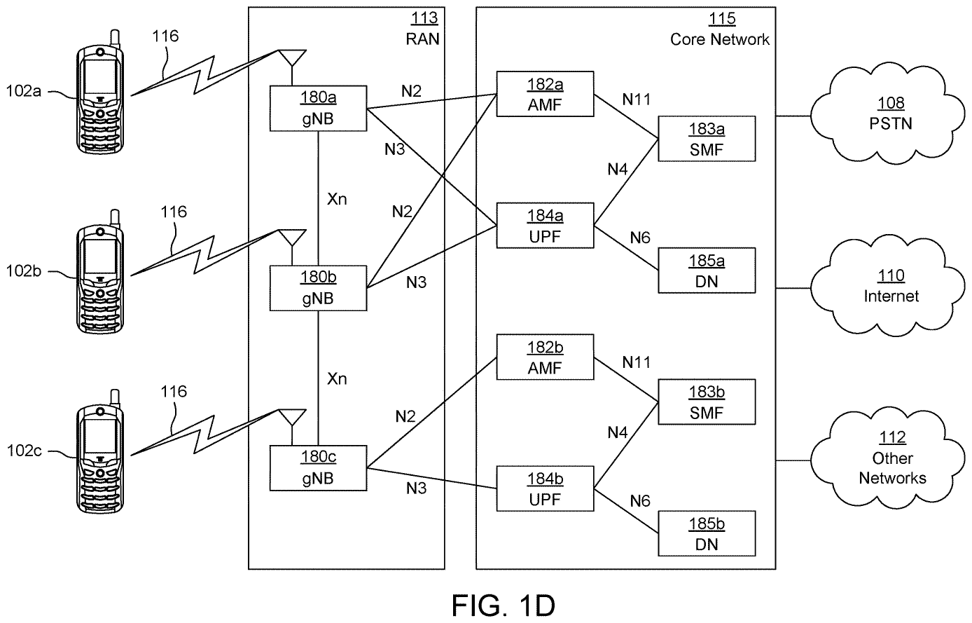

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Doppler Impairments

In the wireless industry, Doppler impairments may pose a limit to the maximum velocity that a transmit/receive point can have to keep a sustainable communication. Doppler is produced by temporal variations of the channel response caused by movement of the transmit/receive points or the surrounding scatterers. As a result, the channel may exhibit amplitude and/or phase fluctuations that depend on any of! the speed, carrier frequency, and the angles of the transmitted/received rays with respect to the velocity vector. Doppler variations may give rise to a phenomenon called channel aging by which the estimates of the channel response get outdated too fast because of mobility, which may impair the ability of channel sounding to estimate, e.g., the precoding matrix indicator (PMI) values in 5G NR, or the ability of the scheduler to assign resources to users based on channel state information (CSI).

Doppler impairments can be broadly classified into two categories: Doppler shift and Doppler spread.
Doppler shift represents a discrete shift in the carrier frequency imposed on the transmit/receive rays because of mobility. When a discrete signal ray has a well-defined angle with respect to the velocity vector of the transmit/receive point, the signal experiences a Doppler shift given by the expression:

$${f}_{d} = {f}_{c} ( v / c ) cos θ ,$$

where f_{c} is the carrier frequency, v is the WTRU speed, c is the speed of light, and θ is the angle between the signal's ray and the velocity vector. This case may be representative of line-of-sight (LOS) scenarios with negligible multipath. When seen in the frequency domain, a Doppler shift can be recognized as a Dirac delta located at a defined frequency with respect to the carrier frequency equal to the magnitude of the Doppler shift (which can be positive or negative). Sometimes, the Doppler spread is taken in this case as equal to the Doppler shift value.
A Doppler spread represents a continuous superposition of Doppler shifts motivated by the presence of multiple scatterers which, when combining their reflected/scattered/diffracted rays towards the receiver, comprise a continuous Doppler spectrum. This may happen when, e.g., multipath components do not reach the receiver with a single angle of arrival but according to some statistical angular distribution, which in turn may give rise to a distribution of Doppler shift values. This scenario is more typical of NLOS with full obstruction of the direct path between transmitter and receiver. The resulting Doppler power spectrum has a spectral width, that may be refer to as Doppler spread, given by the interval (−f_{D}, f_{D}), where f_{D} is the maximum Doppler shift obtained when cos θ=1, i.e., f_{D}=f_{c}(v/c). The most representative example of Doppler spectrum is so-called Clarke-Jakes Doppler spectrum, or classical Doppler, which appears when the received rays follow a uniform angular distribution in azimuth. This model has a U-shape spectrum given by the expression:

$$S ( f ) = \{ \begin{matrix}\frac{1}{π {f}_{D} \sqrt{1 - {( \frac{f}{{f}_{D}} )}^{2}}} & , \vert f \leq {f}_{D} \vert \\ 0 & , \vert f > {f}_{D} \vert\end{matrix}$$

Whatever the shape of the Doppler spectrum is, its Doppler spread value may be inversely proportional to the 50% channel's coherence time, T_{c}, according to the following approximate expression:

$${T}_{c} \approx \frac{0.423}{{f}_{D}} .$$

Doppler variations can be modeled at the receiver side by a multiplicative term in the channel's impulse response that renders it time-variant. Communication systems are usually conceived in blocks, or symbols, of a given duration along which most of the physical-layer processing takes place. If the channel's coherence time is much larger than the symbol's duration, but still comparable to the round-trip time of some basic control mechanisms (e.g., CSI reporting), the usefulness of those control mechanisms will be degraded because of channel aging. Moreover, if the channel's coherence time is comparable to the symbol's duration, the channel may vary significantly over the duration of a symbol and the receiver cannot take a single representative CSI value for demodulation, thereby degrading performance.

The Doppler spread may grow linearly with the product of the speed and the carrier frequency. Hence, Doppler impairments can be increased by an increase in the carrier frequency under constant mobility conditions.

### 3GPP Approach to Combat Doppler (e.g., in 5G NR Release 15-17)

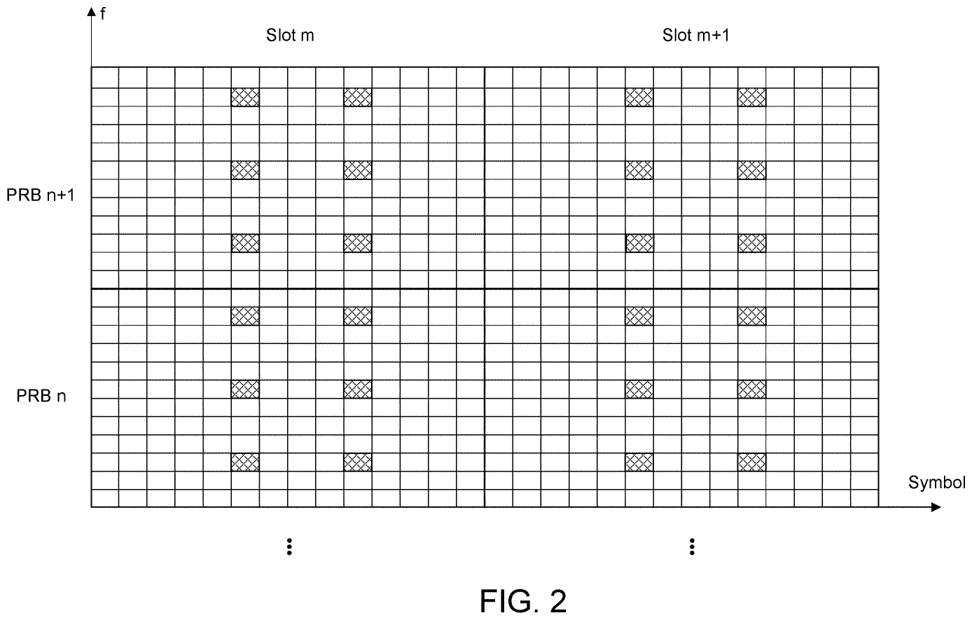

Several techniques have been proposed in the standards to mitigate the harmful effects of Doppler, particularly in high-speed train (HST) scenarios, non-terrestrial networks (NTN), and vehicular-to-everything (V2X) communications. The general approach in these scenarios is to combat the Doppler shift resulting from mobility in LOS scenarios, as happens in, e.g., HST. For example, 5G NR proposes to compensate Doppler in Releases 15 and 16 up to 500 kmph through use of the downlink Tracking Reference Signal (TRS) and the uplink Demodulation Reference Signal (DM-RS). By analysis of their time variations, WTRU and base station (e.g., gNB) can estimate and compensate Doppler shift. TRS signals are a special case of CSI-RS signals used for fine time-frequency tracking by WTRUs. No CSI reporting is expected from them. The TRS resources involve a CSI-RS resource set that may extend over one or two consecutive slots with a frequency density of three resource elements per physical resource block, and two transmit occasions per slot separated by four symbols (see FIG. 2). TRS can be periodically sent and shared among multiple users or triggered aperiodically. TRS may be Quasi-Co-located (QCL)-Type A source for DM-RS and CSI-RS, which means that the Doppler shift and Doppler spread estimated through TRS can also serve for CSI acquisition.

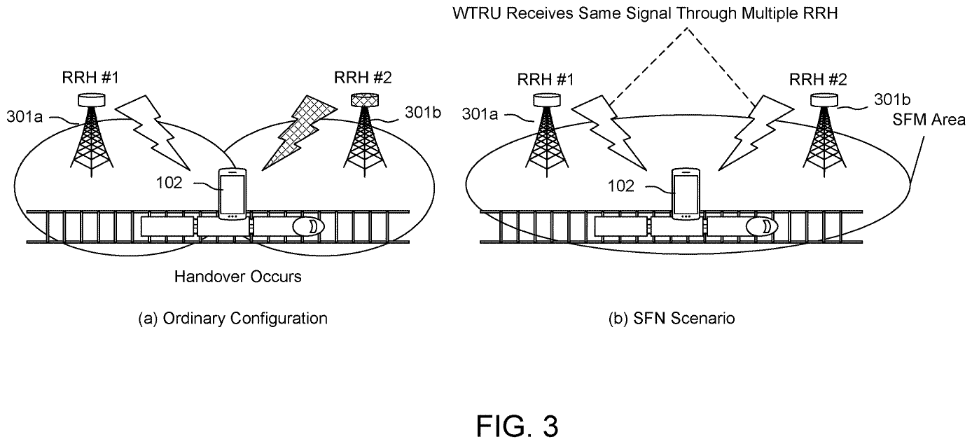

5G NR Release 16 defines so-called Single-Frequency Network (SFN) transmission by multiple Transmit-Receive Points (TRP) where the same Physical Downlink Control Channel (PDCCH) and Physical Downlink Shared Channel (PDSCH) are transmitted by TRPs to avoid frequent handovers (see FIG. 3). A TRP may be a remote radio head (RRH 301a, 301b) as shown in FIG. 3. However, a train-mounted WTRU 102 would estimate large opposite Doppler shifts when measured via TRS from two opposite TRPs. In Release 15 and 16, a single TRS may be QCL source of PDCCH/PDSCH with regards to Doppler. As a result, WTRU might estimate a zero Doppler shift from TRS because TRS is also joint or SFN-transmitted from two opposite TRPs, leading to a combined Doppler shift close to zero.

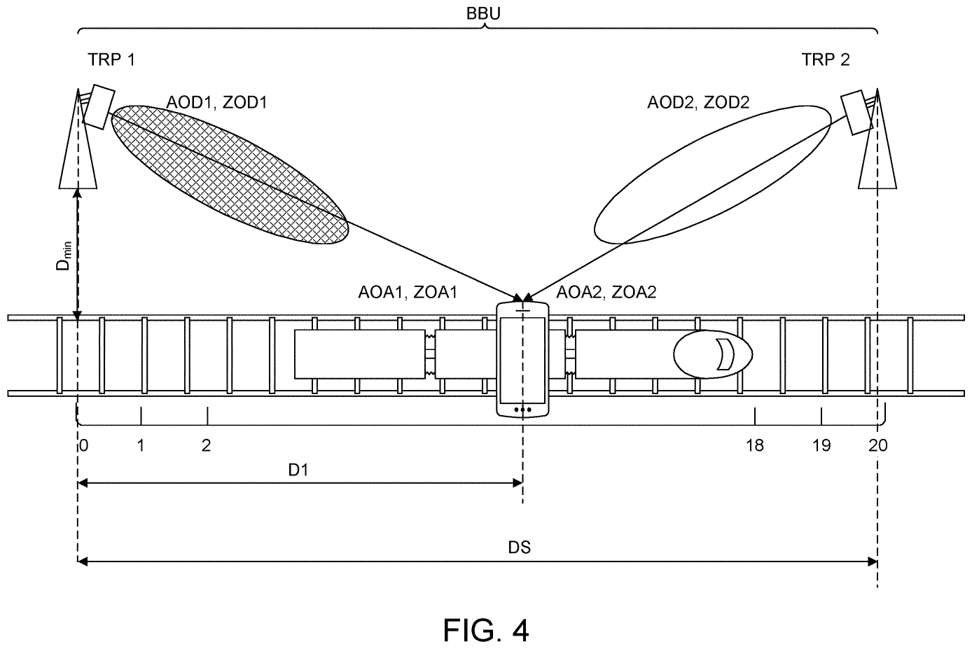

5G NR Release 17 introduces two enhancements to remedy this, with reference to FIG. 4:
Transmission of TRP-specific TRSs. PDCCH and PDSCH can have two different TRS as QCL source for each TRP, so the WTRU can distinguish the Doppler shifts of each and use both to compensate Doppler on reception.
Frequency offset pre-compensation. The base station (e.g., gNB) may estimate the WTRU Doppler shift from SRS transmitted by the WTRU, and pre-compensates the downlink transmission of data and TRS at the second TRP with a negative shift equal to twice the value of the Doppler shift.

### 3GPP Approach to Combat Doppler in NR Release 18

As previous efforts from 3GPP were focused on Doppler shift compensation, more sophisticated solutions are being proposed by companies in NR Release 18.

One aspect is CSI latency, which represents the ultimate bottleneck in signaling when frequent CSI updates are sent in response to high mobility. Another aspect is the refinement of Rel-16/17 Type-II codebook to incorporate time/frequency information including Doppler information and assist precoding in high-speed conditions. Either the WTRU or the base station (e.g., gNB) can perform this prediction, there being an advantage in the latter case from the lack of accuracy in the CSI reports from WTRUs because of quantization errors. The improved codebook structure can contain a series of time-domain precoders with time-domain compression (either based on channel prediction or on entropy-based compression), and different enablers can help predict the channel state based on outdated channel measurements. These approaches are characterized by enhancements to the precoder structure with a three-level structure in codebook-based precoding, with a subsequent increase in the computing power required to estimate the precoding entries. Proposals also consider reporting Doppler or time-domain correlation information by the WTRU to assist the base station (e.g., gNB).

Other solutions may be based on enhancing the codebook to contain delay and Doppler information in a three-stage Doppler-delay-beam precoding structure where the WTRU would select entries based on the acquired channel.

### Angular-Domain Channel Representation

Some aspects of this disclosure can be better understood by working with the angular-domain channel representation. A wireless NLOS Rayleigh channel established between a moving transmitting WTRU and a static base station (e.g., gNB) comprising N_{BS} transmit-receive RF chains, with L taps and Nₚ taps per path, can be written as:

$${h}_{{n}_{t} , {n}_{r}} ( t , τ ) = {\sum }_{l = 0}^{L - 1} {\sum }_{q = 0}^{{N}_{p} - 1} {α}_{l , q} exp j \{ {\underbrace{2 π {f}_{D} cos {θ}_{l , q} t}}_{Doppler shift} + {\underbrace{{ψ}_{{n}_{t}} ( {θ}_{l , q} )}}_{phase shift TX} + {\underbrace{{ψ}_{{n}_{r}}^{′} ( {ϑ}_{l , q} )}}_{phase shift RX} \} δ ( τ - {τ}_{l} ) ,$$

where nₜ and nᵣ denote the transmit and receive antennas respectively, α_{l,g} is the complex gain of q-th path in l-th tap, and θ_{l,q}, ϑl,q are respectively the angle of departure (AoD) and angle of arrival (AoA) of the q-th path in l-th tap. The terms hₙ_{ₜ}_{,n}_{ᵣ}(t, τ) can be arranged into a matrix h with dimension N_{UE}×N_{BS} where N_{UE} is the number of antennas at the WTRU. A superposition of Doppler shifts may exist as per the terms exp j{2πf_{D} cos θ_{l,g} t}, and the phase shifts may be respectively dependent on θ_{l,g} and ϑ_{l,g} on transmission and reception as a function of the specific antenna array configuration. The number of antennas can be equal or higher than N_{BS}.

This expression can be translated to the angular domain by applying a N_{BS}×N_{BS} unitary DFT matrix U with components U_{k,p} given by:

$${U}_{k , p} = \frac{1}{\sqrt{{N}_{B S}}} exp ( \frac{- j 2 π k p}{{N}_{BS}} ) , k , p = 0 , … , {N}_{B S} - 1 .$$

The time-domain angular channel matrix can be expressed as h^{a}=Uh, h=U^{H}h^{a}, and the frequency-domain angular channel matrix H^{a}=UH, H=U^{H}H^{a}. The matrix U may be unitary, e.g., UU^{H}=U^{H}U=I. The channel matrix h^{a} may be the result of mapping the channel state into a new space determined by a set of orthogonal vectors related to the original ones by a DFT, and may express the channel responses at each pair of (transmit antenna at the WTRU) and (beam at the Base Station).

Doppler shifts may be proportional to the cosines of the AoD of each ray. AoD can be estimated with the aid of multi-antenna techniques on the transmit side. There may be a one-to-one relationship between Doppler shift and AoD, because (e.g., only) the transmitter can perfectly distinguish Doppler shifts on uplink.

In contrast, on reception there can be multiple Doppler shifts associated with one AoA, i.e., depending on the geometric environment several rays with different Doppler shifts may arrive at the receiver with the same AoA given the finite spatial resolution of the beams. For this reason, most studies on Doppler mitigation rely on the transmitter to determine the AoD of the signals with enough spatial resolution thanks to multi-antenna structures. This is not practical in most realistic scenarios as the moving transmitter is unlikely to carry large multi-antenna structures.

The status of both literature and industry in relation to Doppler impairments can be summarized as follows:
High-Speed Train scenario in 5G NR contains the most stringent Doppler conditions defined so far for wireless communications, but it only focuses on Doppler shift compensation.
Whereas Doppler shift only applies to pure LOS scenarios, Doppler spread may be more relevant in NLOS scenarios, particularly in so-called Frequency Range 1 (FR1) with carrier frequencies below 6 GHz (sub-6 GHZ).
Most efforts so far are spent on Doppler shift compensation and Doppler spread impairments are much more difficult to mitigate.
The use of many antennas in massive MIMO (M-MIMO), or ultra-massive MIMO (UM-MIMO), has been studied for Doppler mitigation in high-mobility uplink communications employing large uniform linear arrays (ULA) or uniform planar array (UPA) at the transmitter.
ULA/UPA structures may be impractical at the device side because of its size, weight, and complexity, particularly in high-speed environments. In contrast, large antenna arrays are more practical at the Base Station side.
Solutions based on codebook enhancements containing time-domain evolution terms or correlation information, or three-stage precoders with delay-Doppler-beam information, may be complex to implement at the WTRU side and may not have the spatial resolution required to identify well-defined Doppler shifts in the combined DL signal.
No techniques seem to have been developed yet for mobility compensation in NLOS scenarios based on ULA/UPA at the receiver side.

To better cope with Doppler-induced impairments, this disclosure describes changes in the downlink control and data signals and uplink reporting of feedback information to facilitate Doppler mitigation in single-TRP and multi-TRP scenarios. Contrary to the approach in most prior art solutions, Doppler spread is assumed in LOS or NLOS with rich Rayleigh scattering showing a continuous superposition of Doppler shifts in the Doppler power spectrum. A Rician component may also be present in the system, but its contribution is assumed less significant compared to the combined Rayleigh scattering.

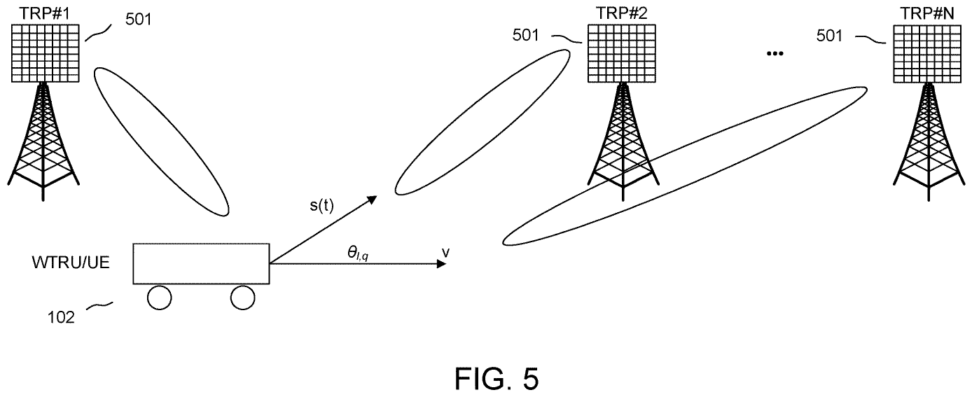

TRPs are assumed to contain a very large number of transmit-receive RF chains in UM-MIMO configuration to enable spatial multiplexing of co-scheduled multi-user MIMO (MU-MIMO) users. Time division duplex (TDD) is also assumed enjoying full uplink-downlink channel reciprocity. In the multi-TRP case, TRPs can cooperate through joint or SFN transmission and reception towards/from the WTRU. A moving WTRU 102 communicates with the one, or multiple, TRPs 501 with a velocity v and angles of departure/arrival θ_{l,g} of the q-th path for transmission/reception of WTRU in the 1-th tap with respect to the velocity vector (see FIG. 5).

In what follows the elements of the present disclosure are explained in detail that will be part of the embodiments described below.

Identification of Doppler Shift Components by the Base Station (e.g., gNB)

As stated in prior-art studies, Doppler shift components could be fully estimated by the moving transmitting WTRU in case having a multi-antenna system with enough spatial resolution, because there is a one-to-one relationship between Doppler shift and AoD as only the moving WTRU can perfectly distinguish Doppler shifts on uplink.

However, with sufficiently large numbers of antennas at the receiving entity, the beams can be so narrow that the Doppler spectrum tends to exhibit a discrete set of Doppler shifts rather than a continuous Doppler spread. With higher numbers of antennas, the likelihood that multiple rays reflected by the surrounding scatterers can reach the receiver within the same receive beam is low, and when that happens, it is reasonable to assume that they will exhibit a discrete set of Doppler shifts (or can be accurately approximated as a discrete set) rather than a continuum of Doppler values. This assumption can be more accurate when scatterers are sufficiently far from the receive antenna structure and spherical wave effects are deemed negligible, as in most realistic scenarios.

For a given user speed, the Doppler shift values of the received beams may depend on macroscopic quantities like the angles of departure of the rays at the transmit side, the geometry of the surrounding scatterers, and/or the scatterers' velocities. Therefore, it is reasonable to assume that the magnitudes of the Doppler shifts may be reciprocal in UL and DL even in non-TDD configurations. In TDD also the amplitudes and phases of the rays showing Doppler shifts can be considered reciprocal in UL and DL.

In some embodiments, based on a given time interval denoted as M, hereinafter called the Doppler observation window, the discrete set of Doppler shifts can be estimated by the base station (e.g., gNB) after taking appropriate uplink measurements from SRS or PUSCH DM-RS signals. Whereas SRS can be available irrespective of the presence or not of uplink data or control channel transmissions, the period of its transmission is usually larger than that of PUSCH DM-RS. PUSCH DM-RS may be (e.g., only) present when PUSCH is transmitted, which may (e.g., needs to) be dynamically scheduled. The base station (e.g., gNB) can therefore resort to more precise Doppler measurements subject to the presence of uplink transmissions (through PUSCH DM-RS) or to less precise measurements independent of UL transmissions (through SRS).

The Doppler observation window M may comprise a time interval over which Doppler shifts are to be estimated. It can be set according to the speed reported by the WTRU, or measured via SRS or PUSCH DM-RS, and further refined based on feedback indications from the WTRU. As described in what follows, such feedback can be based on measurements of the Doppler spread taken on a subset of Doppler-precoded TRS signals assigned to the WTRU. The units of M can be related to the time intervals between consecutive channel observations, e.g., the time lapse between consecutive transmit occasions for UL SRS or PUSCH DM-RS.

### Doppler Precoding

The term “Doppler precoding” will be used hereinafter to refer to any precoding mechanism applied by the base station (e.g., gNB) on one or more downlink control or data signals to pre-compensate the Doppler spread impairments introduced by the user's speed.

Instead of following a Doppler codebook-based approach as in prior art solutions, where the WTRU selects the preferred codebook entries based on downlink Doppler measurements, this disclosure considers an arbitrary non-codebook-based Doppler precoding at the base station (e.g., gNB) side assumed to be applied on the downlink data and control channels, e.g., PDSCH, PDCCH and PT-RS (if present), aimed to minimize Doppler spread at the receiver without impacting the channels and/or layers intended for other users. Doppler precoding is applied to the downlink TRS so that it contains the same Doppler impairments. A closed-loop interaction between base station (e.g., gNB) and WTRU can be then established based on measurements of the Doppler performed on TRS and subsequent reporting to the base station (e.g., gNB). This closed loop is aimed to refine the Doppler precoding process until the Doppler impairments measured at the WTRU side are below an established threshold, after which Doppler precoding can be considered sufficiently accurate and the Doppler observation window can remain stable.

To illustrate an exemplary Doppler precoding process, let us assume that the base station (e.g., gNB) estimates the frequency-domain uplink channel matrices H[nᵢ] at a series of M OFDM symbols n₀, n₁, . . . , n_{M-1} for a given user (where the M consecutive symbols comprise the Doppler observation window), and converts them to the angular representation {H^{a}[nᵢ]=UH[nᵢ], i=0, . . . , M−1}. Furthermore, let us assume that any suitable estimation technique applied at the N_{BS} beams of the angular representation H^{a}[nᵢ] yields a set of estimated discrete Doppler shifts per beam [symbol] ={Σₖ Âₗₖ exp j2π\hat{f}ₗₖn, l=0, . . . , N_{BS}}. By invoking the reciprocity assumption, the base station (e.g., gNB) can apply complex conjugates of the discrete Doppler shifts to pre-compensate Doppler on the downlink. Denoting by X the N_{BS}×1 vector containing the time-domain downlink signal intended for transmission towards the WTRU, the following operation can compensate Doppler through a point-wise multiplication operator ⊙ to yield the Doppler-compensated vector \tilde{X}:

$$\tilde{X} = {U}^{H} ( D ⊙ UX ) ,$$

where a N_{BS}×1 Doppler precoding vector is defined containing the complex conjugates of the estimated Doppler shifts corresponding to each receive beam:

$$D = {( \begin{matrix}{\sum }_{k} {Â}_{0 k}^{*} exp - j 2 π {\hat{f}}_{0 k} n \\ ⋮ \\ {\sum }_{k} {Â}_{{N}_{BS} - 1 , k}^{*} exp - j 2 π {\hat{f}}_{{N}_{BS} - 1 , k} n\end{matrix} )}_{{N}_{BS} \times 1} .$$

Notice that, in case the MIMO precoding operation involves DFT beams as reported within the PMI feedback, the Doppler precoding vector D might stick to the DFT beams pre-selected by the precoder for that WTRU when generating the vector X. In such case, (e.g., only) a subset of beams may be non-zero leaving zero entries at the DFT beams that are not excited according to the PMI reports, e.g.:

$$D = {( \begin{matrix}{\sum }_{k} {Â}_{0 k}^{*} exp - j 2 π {\hat{f}}_{0 k} n \\ ⋮ \\ {\sum }_{k} {Â}_{i k}^{*} exp - j 2 π {\hat{f}}_{i k} n \\ ⋮ \\ 0 \\ ⋮ \\ {\sum }_{k} {Â}_{{N}_{BS} - 1 , k}^{*} exp - j 2 π {\hat{f}}_{{N}_{BS} - 1 , k} n\end{matrix} )}_{{N}_{BS} \times 1} .$$

The described Doppler precoding can be seen as a spatial transformation of the time-domain signals. It can be applied as a last step in the baseband processing chain after the time-domain signal waveform has been generated in X. Other Doppler precoding strategies can be devised either in time domain or frequency domain without departure from the present disclosure. This and other Doppler precoding strategies may be applied as an additional step to any other SU/MU-MIMO precoding scheme aimed to spatially multiplex layers or users.

The Doppler precoding operation may be completely transparent to the user as it involves non-codebook based transformations on the signal. However, a procedure may (e.g., must) be devised so that the WTRU is aware that Doppler precoding is active, or it can trigger Doppler measurements and reporting, so that a closed loop interaction is established to allow further refinement of the process based on WTRU measurements and feedback reporting.

The proposal involves Doppler precoding to be also applied on the downlink TRS signal. Contrary to PDSCH, TRS may comprise a single antenna port and may be usually shared by many WTRUs for fine time-frequency synchronization. As not all users have the same Doppler characteristics per beam, a common precoding scheme may not be applied on TRS as different users would experience different Doppler characteristics in the same beam, and alternative solutions may (e.g., must) be sought.

### Doppler-Precoded TRS Resource Set

To solve the above issue, the concept of Doppler-precoded TRS resource set is introduced. Resources devoted to transmission of TRS are partitioned into multiple Doppler-precoded TRS resource sets. Each Doppler-precoded TRS resource set is assigned to one high-speed WTRU, or multiple high-speed WTRUs that are scheduled with PDSCH on the same time-frequency resources. Each TRS resource set comprises a set of REs containing TRS signals that are not shared with any other TRS resource sets, where a common Doppler precoding is applied and can thus be exploited by users to unambiguously measure the Doppler. Users configured with a TRS resource set will measure the Doppler impairment in the corresponding TRS resource elements and will report back a Doppler indication to the base station (e.g., gNB) containing, e.g., a measured value of the Doppler spread, or a high Doppler indication when it exceeds a pre-configured threshold. Signaling indications of the TRS resource sets may be sent, e.g., as part of the Downlink Control Information (DCI) in a common or a UE-specific PDCCH, or via higher-layer signaling. Configuration of periodic, semi-persistent or aperiodic TRS can be considered, as well as activation/deactivation of semi-persistent TRS and DCI-triggering of aperiodic TRS.

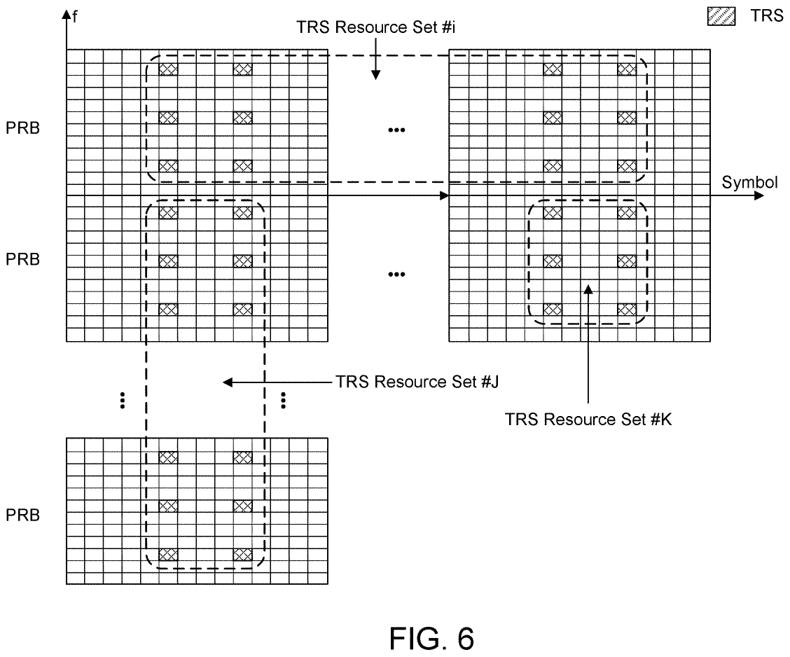

FIG. 6 illustrates three examples of TRS resource sets aimed for three different groups of users that are served by the same cell or TRP and do not share time-frequency resources for transmission of TRS. Non-overlapping sets of TRS signals are assigned to each TRS resource set according to the mobilities and scheduled time-frequency resources of the users involved. As the available resources for TRS signals are limited, the base station (e.g., gNB) should balance the physical resources assigned to each TRS resource set. The more the time resources reserved for a particular TRS resource set, the more the accuracy in estimating Doppler shift components, but also the less resources are available for other TRS resource sets. A minimum number of PRBs may also be advisable for accurate time tracking by WTRUs; the figure (e.g., only) shows a conceptual allocation of TRS signals into TRS resource sets.

In the examples of FIG. 6, non-overlapping TRS resource sets also involve non-overlapping PRBs. It is also possible that TRS signals that belong to different TRS resource sets are shifted within a PRB and/or slot, e.g., 1-2 subcarriers and 1-2 symbols. In this case, TRS resource sets would be non-overlapping while occupying the same PRBs.

In an ultra-massive MIMO scenario, some of the users with sufficiently good signal-to-noise characteristics may be spatially multiplexed by the base station (e.g., gNB) in DL MU-MIMO, and their TRS resource sets will be assigned to groups of users sharing the same time-frequency resources. The TRS resources for the paired users in DL MU-MIMO overlap in time and frequency, but the individual Doppler precoding vectors of each user may be radically different (and, ideally, involve orthogonal beams to avoid interference). Hence, Doppler estimation by WTRUs can be safely performed on these shared resources because of the different DFT beams assigned towards users in MU-MIMO. The number of TRS resource sets is equal to the number of high-speed user groups created by the base station (e.g., gNB) scheduler after MU-MIMO pairing in DL. Obviously, users not in high-speed conditions may not be eligible for Doppler pre-compensation if their channel variations are deemed negligible over the duration of a symbol. These users would not be assigned a TRS resource set and their data channels would not be Doppler-precoded.

Some of the users may also not be spatially multiplexed with others, either because they do not have sufficiently good SNR, or because their channel properties do not make it advisable to pair them in MU-MIMO, or from bursty traffic. In these cases, the TRS resource set for these WTRUs would not be shared with other users.

To illustrate the Doppler precoding of the TRS resource sets, let T^{(l)} be the vector containing the time-domain TRS signals assigned to the i-th TRS resource set that corresponds to one or more high-speed WTRUs. The base station (e.g., gNB), after analysis of the beams corresponding to the users assigned to that TRS resource set, obtains a set of Doppler shifts per beam and constructs the Doppler precoding vector for the i-th TRS resource set as follows:

$$D = {( \begin{matrix}{\sum }_{k} {Â}_{0 k}^{( i ) *} exp - j 2 π {\hat{f}}_{0 k}^{( i )} n \\ ⋮ \\ {\sum }_{k} {Â}_{{N}_{BS} - 1 , k}^{( i ) *} exp - j 2 π {\hat{f}}_{{N}_{BS} - 1 , k}^{( i )} n\end{matrix} )}_{{N}_{BS} \times 1} .$$

Doppler pre-compensation for the i-th TRS resource set can then comprise the following operation:

$${\tilde{T}}^{( i )} = {U}^{H} ( {D}^{( i )} ⊙ {UT}^{( i )} ) .$$

This operation can be performed for each of the TRS resource sets that are eligible for Doppler pre-compensation of high-speed WTRUs.

A WTRU may be configured with periodic TRS and aperiodic TRS, with the periodic TRS being a QCL source RS for the aperiodic TRS. PDCCH DMRS and/or PDSCH DMRS may have the aperiodic TRS as QCL source RS. In state-of-the-art systems, the QCL type may include the parameters Doppler shift, Doppler spread, average delay, delay spread (QCL type A in 5G NR). It may be beneficial to perform Doppler precoding on the aperiodic TRS, but not on the periodic TRS, since the aperiodic TRS may be triggered just before data transmission and the Doppler precoding may be based on the most recent Doppler parameter estimates. Hence, the periodic TRS may be a QCL source RS for the target aperiodic TRS with respect to time-related parameters, e.g., a modified QCL type A including average delay and delay spread but not Doppler shift or Doppler spread.

In another example, PDCCH DMRS and/or PDSCH DMRS may have two TRS as QCL source RS, with the first TRS being QCL source for time-related parameters, e.g., average delay and delay spread, while the second TRS being QCL source for Doppler-related parameters, e.g., Doppler shift and Doppler spread. The first and second TRS may be periodic or aperiodic. In one example, the second TRS is an aperiodic TRS and the first TRS is a periodic TRS, with the first TRS being the QCL source to the second TRS with respect to time-related parameters.

In some cases, an RS used as QCL source for Doppler related parameters is not a legacy TRS, but for instance a modified TRS or a Doppler-tracking RS, which may have different properties than a TRS, e.g., minimum bandwidth, span in time, etc. In some case, an RS used as QCL source for Doppler related parameters, e.g., the second TRS, may have a synchronization signal/PBCH block (SSB) as a source RS. For example, the second TRS may instead be an SSB.

### Feedback Reporting and Signaling

### Doppler-Related Feedback Reporting and Signaling by WTRU

The WTRU, upon detection of appropriate signaling, can measure the Doppler experienced at the resource elements contained in the assigned TRS resource set, and report it back to the base station (e.g., gNB) (or an indication that its value exceeds a given threshold) to give feedback on the Doppler precoding process. As a result of Doppler precoding, TRS may suffer lower impact from Doppler as compared to the case where no Doppler precoding is applied. The WTRU feedback can be used by the base station (e.g., gNB) to further refine the Doppler estimation and precoding process in the subsequent transmissions. Doppler precoding relies on effective estimation of the Doppler shift components per user and beam in the angular-domain channel matrix, which in turn depends on the duration of the Doppler observation window M and the ability of the base station (e.g., gNB) to identify the variations of SRS and/or PUSCH DM-RS signals.

A CSI reporting configuration that is associated with one or more TRS (e.g., in an associated CSI resource configuration) may include a report quantity parameter set to ‘Doppler’. Such a CSI reporting configuration may imply WTRU measurement and reporting of Doppler based on the one or more TRS. The number of reported Doppler measurements may be configurable in the reporting configuration. For the case that the CSI resource configuration includes more TRS than the number of reported Doppler measurements, the WTRU may report (e.g., only) the Doppler measurements for the TRS with highest Doppler, together with corresponding CSI-RS resource indexes (CRI).

Doppler reporting may be dependent on the number of CORESET configured in a bandwidth part (BWP). In a multi-TRP scenario, different CORESET may be mapped to one or different TRPs. In some implementations, one Doppler reporting could be aimed for all TRPs. In other implementations there could be individual reporting of Doppler measurements to TRPs. Whether one or multiple Doppler reporting messages are sent to TRPs may be dependent on the implementation.

Measurement of Doppler can be performed by the WTRU in several ways:
The Doppler power spectrum can be obtained at the WTRU side by performing a DFT of the autocorrelation function, estimated via TRS, by means of the expressions:

$$R [ m ] = 𝔼 \{ {\tilde{T}}^{( i )} [ n ] {\tilde{T}}^{* ( i )} [ n + m ] \} ,$$

$$S [ k ] = D F T \{ R [ m ] \} .$$

where T⁽¹⁾[n] represents the value of the i-th TRS resource set at symbol n, \tilde{T}*⁽ⁱ⁾ is its conjugate value, and the expectation operator [symbol] should be applied over frequency and time. The width of S[k] is a measure of the Doppler spread. Doppler spread can then be explicitly reported to the base station (e.g., gNB), or assigned one out of a set of Doppler categories so that its value (e.g., an integer expressing the category) is sent to the base station (e.g., gNB) to reduce the reporting overhead.
The level crossing rate L, defined as the number of times that a signal envelope r crosses a given threshold R in the downward direction, can be related to the Doppler spread in Rayleigh channels by the expression:

$$L = \sqrt{2 π} {ρ}_{m} r exp - {r}^{2} ,$$

where ρₘ is the Doppler spread, r=R/Rᵣₘₛ and Rᵣₘₛ is the signal's rms value. For a more general Rician channel with Rician factor K the expression becomes:

$$L = \sqrt{2 π ( K + 1 )} {ρ}_{m} r exp [ - K - ( K + 1 ) {r}^{2} ] {I}_{0} ( 2 r \sqrt{K ( K + 1 )} ) ,$$

with I₀ being the modified Bessel's function of 0-th order. In NLOS scenarios with rich scattering, K is close to 0 and a pure Rayleigh expression may be sufficiently accurate. Estimates of the level crossing rate L performed on the TRS resource set can therefore be exploited to estimate Doppler spread.

Signaling indication of the assigned TRS resource set may (e.g., must) be received by the WTRU to be able to measure the Doppler at its TRS occasions.

Reporting of Doppler may be performed via an uplink data or control channel, e.g., PUCCH or PUSCH, or a MAC-CE command. The WTRU may also report an indication of Doppler exceeding a pre-defined threshold configured by the base station (e.g., gNB) via downlink control signaling.

Reporting of Doppler may be performed periodically or aperiodically, or in a semi-persistent fashion. Reporting of Doppler may also be triggered based on demand or condition(s). Similar reporting mechanism may also be applied to reporting an indication of Doppler exceeding a (pre-)configured threshold by base station (e.g., gNB). The reporting above may be activated when needed or deactivated if the reporting is no longer needed. The activation and deactivation may be based on MAC CE. For explicit triggering, the triggering may be based on DCI.

Inference of the Doppler shift components per beam and sizing of the Doppler observation window can be facilitated by a WTRU speed indication, either reported by the WTRUs or estimated via measurements. WTRU speed can be estimated by the base station (e.g., gNB) through analysis of the uplink SRS signals, although this can pose some challenges related to the quality of SRS measurements at cell edge or insufficient number of SRS resources in a cell compared to the number of active WTRUs. SRS quality may also be impacted by the Inter-Carrier Interference (ICI) experienced by high-speed WTRUs because of Doppler. PUSCH DM-RS signals can also be used by the base station (e.g., gNB) for speed measurements, but they are (e.g., only) available when PUSCH is present. WTRUs can alternatively send a speed indication through uplink reporting, with a periodicity given by the rate of variation of the user's speed, or an indication that speed exceeds a given pre-configured threshold.

WTRU speed can help the base station (e.g., gNB) determine the length of the observation window needed to estimate Doppler shift components per beam. In addition, it also helps determine the periodicity of TRS resource sets as per the rate of change of the WTRUs' channel states. Speed indications can be reported by WTRUs on a persistent, semi-persistent, event-triggered or on-demand basis. Triggers for sending a speed indication may comprise, e.g., a successful cell selection or reselection, a cell handover, a relative change in WTRU speed above a given threshold, or a request by the base station via, e.g., MAC-CE command, among others.

Feedback reporting by the WTRU may not impact the reception of PDSCH channels, for which legacy procedures can be followed by the WTRU irrespective of the presence or not of Doppler-precoded signals sent by the base station (e.g., gNB). The same happens with PUSCH transmission except when a MAC-CE command or UCI field is multiplexed with user data, in which case PUSCH may (e.g., needs to) properly allocate the signaling indication.

Doppler-Related Signaling by Base Station (e.g., gNB)

The base station (e.g., gNB) may signal two control indications to WTRUs for which Doppler precoding is applied:
An indication related to the application of Doppler precoding (e.g., configuration information for doppler precoding) on downlink, or the triggering of Doppler measurements and reporting by the WTRU. Such indication can be a simple on/off signaling contained within the DL DCI information corresponding to the scheduled WTRUs, a MAC-CE command, or suitable RRC configuration information. The indication may contain a triggering signal to activate Doppler measurements by the WTRU upon fulfillment of certain events, or a threshold which, when exceeded by the measured Doppler, can trigger a high-speed indication towards the base station (e.g., gNB).
An indication about the TRS resource set assigned to the WTRU. The TRS resource set may be signaled based on a pre-defined codebook of TRS resource sets, an (e.g., explicit indication) of the REs involved in each TRS resource set, or other signaling mechanism depending on the implementation. It may also be based on standard NR TRS configuration or on any suitable variation of it depending on the implementation.

Signaling indications can be sent through DL control signaling, e.g., via the DL DCI field in the PDCCH channel, or via MAC-CE commands or Radio Resource Control (RRC) configuration. A TRS codebook of pre-defined TRS resource sets may also be broadcast in the cell by means of higher layer signaling or System Information, and indications of the TRS resource set may refer to suitable indices in the TRS codebook.

Doppler Precoding and Compensation at the Base Station (e.g., gNB)

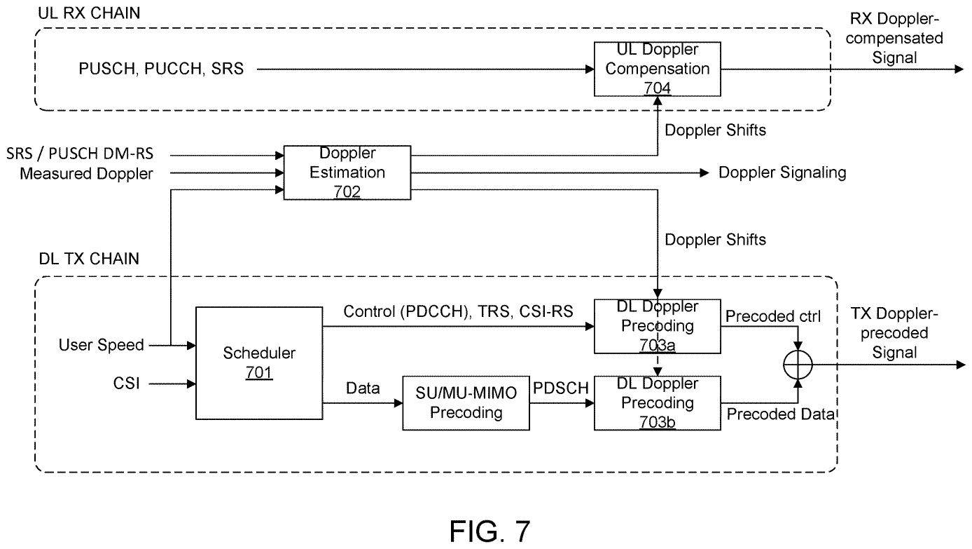

FIG. 7 illustrates the mechanism for Doppler precoding and compensation at the base station (e.g., gNB) side. It shows the generation of Doppler-precoded data (PDSCH), control (PDCCH), and reference signals (DM-RS, PT-RS, TRS, CSI-RS) in the downlink, and the Doppler compensation of uplink data and control (PUSCH and PUCCH) as well as SRS resources for PUSCH CSI acquisition not involving user speed. Precoding of control channel assumes that PDCCH is UE-specific and not shared by multiple WTRUs, and precoding of CSI-RS targets CSI-RS resource sets aimed for DL CSI acquisition.

The downlink processing steps (e.g., first) may comprise a scheduler block 701 that takes the reported and/or measured quantities of users' speed and CSI to perform user grouping for SU/MU-MIMO precoding. TRS resources may be (e.g., then) partitioned into one or multiple TRS resource sets assigned to the user groups paired by the scheduler. The Doppler estimation block 702 may take as inputs the UL SRS and/or PUSCH DM-RS signals, the Doppler measurements or indications reported by WTRUs, and the user's speed (or an indication that it exceeds a given threshold) to configure the Doppler observation window and perform estimation of the Doppler shift components. Doppler shifts may be (e.g., then) exploited by the DL Doppler precoding block 703a, 703b to pre-code the control, data and reference signals, and by the UL Doppler compensation block 704 to compensate the Doppler impairments in the UL PUSCH, PUCCH and SRS resources aimed for PUSCH CSI acquisition. Doppler compensation may involve the same operations as Doppler precoding the (e.g., only) difference being that they may be applied on the uplink received signals instead of the downlink signals.

DL signaling indications are sent by the base station (e.g., gNB) to inform the WTRU about Doppler precoding, or to trigger Doppler measurements, and to inform about the TRS resource sets. This information can be sent according to the principles stated above.

### Joint or SFN Transmission in Multi-TRP Scenario

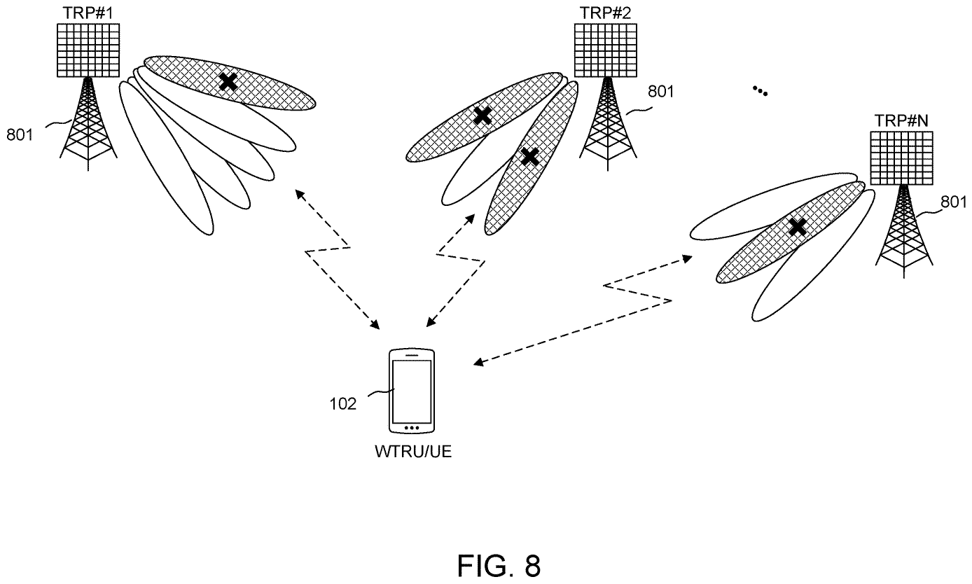

In a case where there are multiple TRPs that are SFN or jointly transmitting/receiving towards/from a given WTRU, Doppler precoding and Doppler compensation may be performed individually by each TRP. As beams can be independently managed by TRPs, spatial directions for which Doppler could not be correctly estimated or compensated by a TRP may be aided by beams in other TRPs for which Doppler estimation and precoding may be more effective. This is illustrated in FIG. 8 where N TRPs 801 may apply Doppler precoding on some of the beams (marked in white) while others may not be successful and thus remain un-precoded (marked with an X). The extra diversity provided by joint or SFN transmissions from multiple TRPs can partially compensate the beams lacking Doppler precoding.

In a multi-TRP scenario, TRS resource sets can be different for different TRPs and Doppler can be independently reported to the TRPs through analysis of their corresponding TRS resource sets.

Estimation of the Doppler shift components per beam may be used by multiple TRPs in joint or SFN transmission to compensate Doppler in the UL direction, e.g., in the PUSCH channel. Beams for which no successful Doppler estimation was achieved by one TRP may be compensated by beams received by other TRPs for which Doppler estimation was successful. The symmetry of the Doppler precoding and compensation procedures is highlighted by the bi-directional arrows in FIG. 8.

Closed-Loop Interaction Between Base Station (e.g., gNB) and WTRU

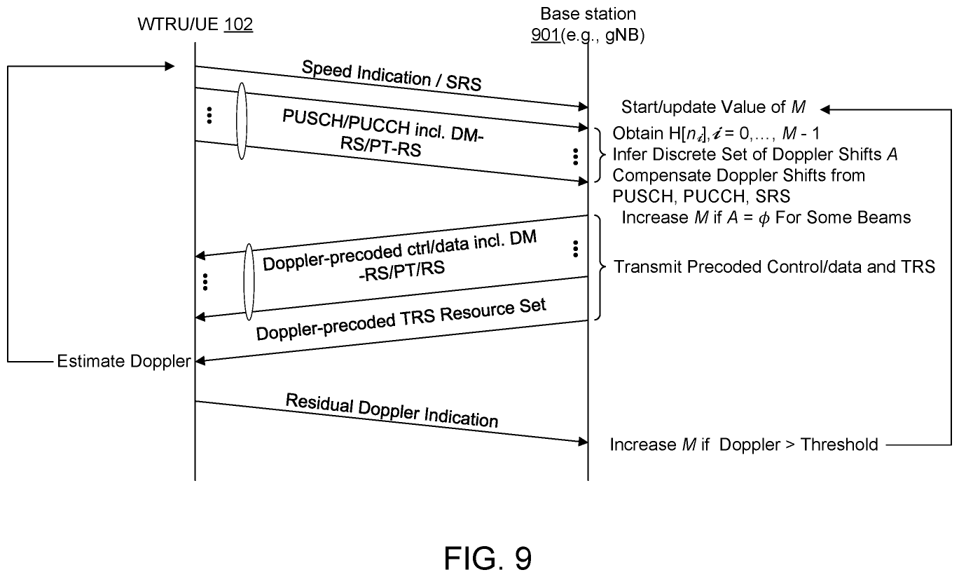

A schematic closed-loop interaction between base station (e.g., gNB) 901 and WTRU 102 is illustrated in FIG. 9. The WTRU 102 may send a speed indication to the base station (e.g., gNB) on a periodical, semi-periodical, event-triggered, or on-demand fashion. The base station (e.g., gNB) may estimate the WTRU speed, for example, by analysis of the SRS signal. The base station (e.g., gNB) 901, for example based on the WTRU speed and any current or previous feedback about Doppler, may adjust the Doppler observation window M and/or may perform statistical analysis of the Doppler shift components over the channel responses H[nᵢ], i=0, . . . , M−1, obtained, for example, from SRS or PUSCH DM-RS.

The set [symbol] of Doppler shifts may contain no Doppler shifts for certain beams because of, e.g., insufficient observation time or lack of accuracy of the inference method. In such cases, the base station (e.g., gNB) 901 may decide to increase M or apply more computing resources to the analysis of Doppler components.

The base station (e.g., gNB) 901 may perform Doppler compensation of the PUSCH and PUCCH channels (including DM-RS and PT-RS) and SRS, and Doppler precoding of control/data signals (including DM-RS and PT-RS) and the TRS resource set. The WTRU 102 may receive the Doppler-precoded signals and may measure Doppler, for example, by analysis of the TRS resource set assigned to that WTRU 102. Proper feedback to the base station (e.g., gNB) 901 containing Doppler measurements, or an indication of Doppler being above a pre-defined threshold, may close the loop and may allow further refinement of the observation window M and the Doppler precoding process. If the Doppler is higher than a given threshold, the base station (e.g., gNB) may increase the observation window M and/or dedicate more computing resources to Doppler estimation.

The turnaround time of the algorithm may be such that it can respond to macroscopic, or large-scale, variations of the channel's geometry because of, e.g., changes in the angles of arrival or departure of the rays. The timescale may be related to the macroscopic variations of the channel's environment, velocities, and angles, and is therefore higher than the channel's coherence time (which responds to much faster microscopic, or small-scale, fluctuations of the signal from constructive/destructive interference between the reflected rays).

In a multi-TRP scenario with joint or SFN transmission the described steps can be performed between the WTRU and each TRP that keeps a connection with the WTRU. Beams for which no successful Doppler shift estimation is possible during the Doppler estimation process may remain non-compensated for that TRP. Joint or SFN transmission in multi-TRP can provide additional diversity and Doppler compensation capabilities by more than one TRP in case some beams are left non-compensated, transparently to the WTRU.

All the above transmit/receive processing steps will be better understood through the exemplary embodiments described below.

### Exemplary Embodiments

### Transmission of Signals Based on Doppler Precoding

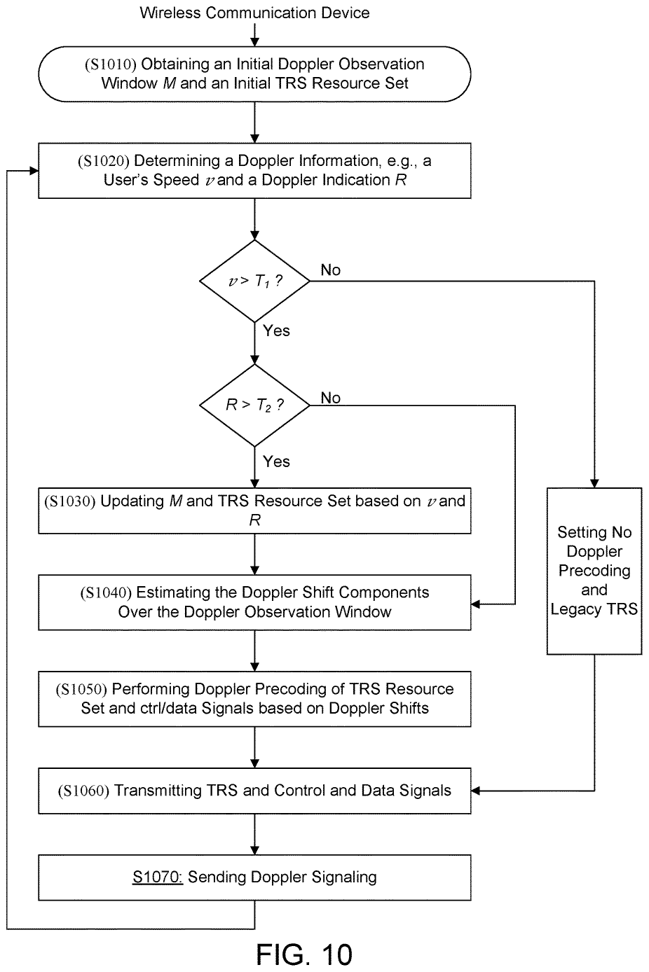

In an exemplary embodiment exemplified in FIG. 10, a first wireless communication device or set of first wireless communication devices transmitting wireless signals to a second wireless communication device or set of second wireless communication devices, are characterized by any of the following steps:
(S1010) obtaining an initial duration of a Doppler observation window and an initial TRS resource set, e.g., from higher-layer signaling;
(S1020) determining a Doppler information from the second wireless communication device or set of second wireless communication devices, e.g., a user's speed v and a Doppler indication R;
(S1030) updating the Doppler observation window and the TRS resource set based on the Doppler information, e.g., the user's speed above a first threshold T₁ and the Doppler R above a second threshold T₂;
(S1040) estimating the Doppler shift components characterizing the signals received from the second wireless communication device or set of second wireless communication devices over the duration of the Doppler observation window;
(S1050) performing Doppler precoding of the TRS resource set and the control and data signals based on the estimated Doppler shift components, and (S1060) transmitting TRS and control and data signals towards the second wireless communication device or set of second wireless communication devices; and
(S1070) sending Doppler signaling to the second wireless communication device or set of second wireless communication devices containing, e.g., the TRS resource set or a Doppler indication.

According to embodiments, the second wireless communication device or set of second wireless communication devices can be scheduled in shared time-frequency resources for MU-MIMO transmission of data over, e.g., a PDSCH channel.

According to embodiments, the first wireless communication device or set of first wireless communication devices may transmit signals to the second wireless communication device or set of second wireless communication devices in a multi-TRP single-frequency network (SFN) or joint transmission.

According to embodiments, the thresholds T₁ and T₂ may be pre-configured via higher layer signaling, e.g., through RRC configuration information or System Information.

According to embodiments, the Doppler observation window may comprise a series of time intervals over which one or multiple signals are sent by the second wireless communication device or set of second wireless communication devices for channel state information acquisition, e.g., through SRS or PUSCH DM-RS.

According to embodiments, the initial duration of the Doppler observation window may be individually set for each second wireless communication device or set of second wireless communication devices based on the user's speed.

According to embodiments, the TRS resource set may comprise a set of resource elements in one or several OFDM symbols and one or several physical resource blocks, for transmission of TRS signals to a second wireless communication device or set of second wireless communication devices that share the same time-frequency resources for transmission of data.

According to embodiments, the TRS resource set is determined in such a way that no overlap occurs between the resource elements contained in two different TRS resource sets.

According to embodiments, the physical resource elements contained in a TRS resource set share the same Doppler precoding operation.

According to embodiments, the TRS resource set may be assigned to a second wireless communication device or set of second wireless communication devices whose speeds are above the threshold T₁.

According to embodiments, the user's speed may be contained in a report sent by the second wireless communication device or set of second wireless communication devices through a shared data channel, e.g., PUSCH.

According to embodiments, the user's speed may be estimated by the first wireless communication device or set of first wireless communication devices by analyzing the time-domain variations of the signals received from the second wireless communication device or set of second wireless communication devices, e.g., SRS or PUSCH DM-RS, in the duration of the Doppler observation window.

According to embodiments, the Doppler may be measured by the second wireless communication device or set of second wireless communication devices over the TRS signals contained in the assigned TRS resource set.

According to embodiments, the Doppler indication may be expressed as the amount of Doppler spread, or the rate of variation of the channel state, as measured by the second wireless communication device or set of second wireless communication devices.

According to embodiments, the Doppler indication may be reported by the second wireless communication device or set of second wireless communication devices through a shared data channel, e.g., PUSCH.

According to embodiments, the Doppler observation window may be increased by a given number of symbols if the Doppler is higher than threshold T₂.

According to embodiments, the Doppler shift components may be estimated by the first wireless communication device or set of first wireless communication devices from analysis of the temporal evolution of the beams characterizing the angular-domain channel matrix over the duration of the Doppler observation window.

According to embodiments, the Doppler shift components may be estimated in a Time-Division Duplex system from the signals sent by the second wireless communication device or set of second wireless communication devices for channel state acquisition, e.g., SRS or PUSCH DM-RS.

According to embodiments, the angular-domain channel matrix may be obtained by the first wireless communication device or set of first wireless communication devices through multiplication of a unitary DFT matrix with the time-domain or frequency-domain channel matrix obtained at the radio frequency chains in a multi-antenna system.

According to embodiments, the Doppler precoding operation involves the multiplication of the angular-domain channel matrix and a vector containing the complex conjugates of the Doppler shift components estimated at each received beam.

According to embodiments, the Doppler precoding operation may contain non-null entries at the DFT beams selected for MU-MIMO transmission towards the second wireless communication device or set of second wireless communication devices that are scheduled at the same time-frequency resources.

According to embodiments, the Doppler precoding operation may involve a data channel, e.g., PDSCH.

According to embodiments, the Doppler precoding operation may involve a UE-specific control channel, e.g., PDCCH.

According to embodiments, the Doppler precoding operation may involve a reference signal for channel estimation, e.g., CSI-RS for downlink channel acquisition.

According to embodiments, the Doppler precoding operation may involve a reference signal for demodulation, e.g., DM-RS or PT-RS.

According to embodiments, the Doppler precoding operation of the data channel may be performed after the SU-MIMO, or MU-MIMO, spatial precoding operation.

According to embodiments, the Doppler signaling indication may comprise an index to a pre-defined codebook of TRS resource sets, or an explicit indication of the time-frequency resources assigned to the TRS resource set.

According to embodiments, the Doppler signaling indication may comprise a field to notify whether Doppler precoding is applied to the data and the TRS resource set.

According to embodiments, the Doppler signaling indication may comprise a field to trigger the measurement and reporting of Doppler by the second wireless communication device or set of second wireless communication devices.

According to embodiments, the Doppler signaling indication may be sent to the second wireless communication device or set of second wireless communication devices via control information, e.g., DCI, MAC-CE signaling, or RRC configuration information.

According to embodiments, the first wireless communication device may be a base station and the second wireless communication device may be a user equipment (e.g., WTRU) in the downlink of a wireless communication system.

According to embodiments, the first wireless communication device may be a roadside unit and the second wireless communication device may be a user equipment (e.g., WTRU) in the sidelink of a wireless communication system.

According to embodiments, the set of first wireless communication devices may be multiple transmit-receive points in the downlink of a multi-TRP Single-Frequency Network (SFN) or joint transmission.

According to embodiments, the second wireless communication device may be a user equipment (e.g., WTRU) in the downlink or the sidelink of a wireless communication system.

According to embodiments, the set of second wireless communication devices may be user equipment (e.g., WTRU) sharing the same time-frequency resources in the downlink of a MU-MIMO transmission.

According to embodiments, the wireless links between the first wireless communication device or set of first wireless communication devices and the second wireless communication device or set of second wireless communication devices may be characterized by line-of-sight or non-line of sight conditions with full or partial obstruction of the direct ray.

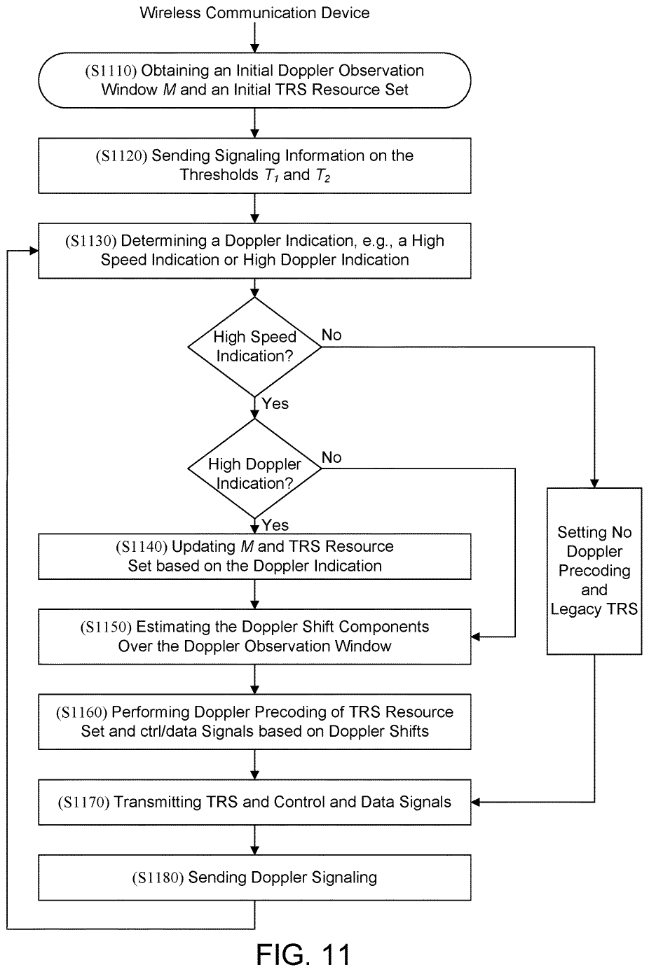

In another exemplary embodiment exemplified in FIG. 11, a first wireless communication device or set of first wireless communication devices transmitting wireless signals to a second wireless communication device or set of second wireless communication devices, are characterized by:
(S1110) obtaining an initial duration of a Doppler observation window and an initial TRS resource set, e.g., from higher-layer signaling;
(S1120) sending signaling to the second wireless communication device or set of second wireless communication devices containing a first threshold T₁ and a second threshold T₂;
(S1130) determining a Doppler indication from the second wireless communication device or set of second wireless communication devices, e.g., a high-speed indication or a high Doppler indication;
(S1140) updating the Doppler observation window and the TRS resource set based on said Doppler indication;
(S1150) estimating the Doppler shift components characterizing the signals received from the second wireless communication device or set of second wireless communication devices over the duration of the Doppler observation window;
(S1160) performing Doppler precoding of the TRS resource set and the control and data signals based on the estimated Doppler shift components, and (S1170) transmitting TRS and control and data signals towards the second wireless communication device or set of second wireless communication devices; and
(S1180) sending Doppler signaling to the second wireless communication device or set of second wireless communication devices.

According to embodiments, the second wireless communication device or set of second wireless communication devices can be scheduled in shared time-frequency resources for MU-MIMO transmission of data over, e.g., a PDSCH channel.

According to embodiments, the first wireless communication device or set of first wireless communication devices may transmit signals to the second wireless communication device or set of second wireless communication devices in a multi-TRP single-frequency network (SFN) or joint transmission.

According to embodiments, the thresholds T₁ and T₂ may be pre-configured via higher layer signaling, e.g., through RRC configuration information or System Information.

According to embodiments, a signaling indication of the thresholds T₁ and T₂ may be sent to the second wireless communication device or set of second wireless communication devices via control information, e.g., DCI, MAC-CE signaling, or RRC configuration information.

According to embodiments, a high-speed signaling indication may be triggered by the second wireless communication device or set of second wireless communication devices in case the user's speed exceeds said threshold T₁.

According to embodiments, a high Doppler signaling indication may be triggered by the second wireless communication device or set of second wireless communication devices in case the measured Doppler exceeds said threshold T₂.

According to embodiments, the Doppler indications may be sent by the second wireless communication device or set of second wireless communication devices via control information, e.g., UCI, MAC-CE signaling, or RRC configuration information.

According to embodiments, the Doppler observation window may comprise a series of time intervals over which one or multiple signals are sent by the second wireless communication device or set of second wireless communication devices for channel state information acquisition, e.g., through SRS or PUSCH DM-RS.

According to embodiments, the initial duration of the Doppler observation window may be individually set for each second wireless communication device or set of second wireless communication devices based on the user's speed.

According to embodiments, the TRS resource set may comprise a set of resource elements in one or several OFDM symbols and one or several physical resource blocks, for transmission of TRS signals to a second wireless communication device or set of second wireless communication devices that share the same time-frequency resources for transmission of data.

According to embodiments, the TRS resource set is determined in such a way that no overlap occurs between the resource elements contained in two different TRS resource sets.

According to embodiments, the physical resource elements contained in a TRS resource set share the same Doppler precoding operation.

According to embodiments, the TRS resource set may be assigned to a second wireless communication device or set of second wireless communication devices whose speeds are above the threshold T₁.

According to embodiments, the Doppler may be measured by the second wireless communication device or set of second wireless communication devices over the TRS signals contained in the assigned TRS resource set.

According to embodiments, the Doppler observation window may be increased by a given number of symbols if an indication of high Doppler is received from the second wireless communication device or set of second wireless communication devices.

According to embodiments, the Doppler shift components may be estimated by the first wireless communication device or set of first wireless communication devices from analysis of the temporal evolution of the beams characterizing the angular-domain channel matrix over the duration of the Doppler observation window.

According to embodiments, the Doppler shift components may be estimated in a Time-Division Duplex system from the signals sent by the second wireless communication device or set of second wireless communication devices for channel state acquisition, e.g., SRS or PUSCH DM-RS.

According to embodiments, the angular-domain channel matrix may be obtained by the first wireless communication device or set of first wireless communication devices through multiplication of a unitary DFT matrix with the time-domain or frequency-domain channel matrix obtained at the radio frequency chains in a multi-antenna system.

According to embodiments, the Doppler precoding operation involves the multiplication of the angular-domain channel matrix and a vector containing the complex conjugates of the Doppler shift components estimated at each received beam.

According to embodiments, the Doppler precoding operation may contain non-null entries at the DFT beams selected for MU-MIMO transmission towards the second wireless communication device or set of second wireless communication devices that are scheduled at the same time-frequency resources.

According to embodiments, the Doppler precoding operation may involve a data channel, e.g., PDSCH.

According to embodiments, the Doppler precoding operation may involve a UE-specific control channel, e.g., PDCCH.

According to embodiments, the Doppler precoding operation may involve a reference signal for channel estimation, e.g., CSI-RS for downlink channel acquisition.

According to embodiments, the Doppler precoding operation may involve a reference signal for demodulation, e.g., DM-RS or PT-RS.

According to embodiments, the Doppler precoding operation of the data channel may be performed after the SU-MIMO, or MU-MIMO, spatial precoding operation.

According to embodiments, the Doppler signaling indication may comprise an index to a pre-defined codebook of TRS resource sets, or an explicit indication of the time-frequency resources assigned to the TRS resource set.

According to embodiments, the Doppler signaling indication may comprise a field to notify whether Doppler precoding is applied to the data and the TRS resource set.

According to embodiments, the Doppler signaling indication may comprise a field to trigger the measurement of Doppler by the second wireless communication device or set of second wireless communication devices.

According to embodiments, the Doppler signaling indication may be sent to the second wireless communication device or set of second wireless communication devices via control information, e.g., DCI, MAC-CE signaling, or RRC configuration information.

According to embodiments, the first wireless communication device may be a base station and the second wireless communication device may be a user equipment (e.g., WTRU) in the downlink of a wireless communication system.

According to embodiments, the first wireless communication device may be a roadside unit and the second wireless communication device may be a user equipment (e.g., WTRU) in the sidelink of a wireless communication system.

According to embodiments, the set of first wireless communication devices may be multiple transmit-receive points in the downlink of a multi-TRP Single-Frequency Network (SFN) or joint transmission.

According to embodiments, the second wireless communication device may be a user equipment (e.g., WTRU) in the downlink or the sidelink of a wireless communication system.

According to embodiments, the set of second wireless communication devices may be user equipment (e.g., WTRU) sharing the same time-frequency resources in the downlink of a MU-MIMO transmission.

According to embodiments, the wireless links between the first wireless communication device or set of first wireless communication devices and the second wireless communication device or set of second wireless communication devices may be characterized by line-of-sight or non-line of sight conditions with full or partial obstruction of the direct ray.

### Reception of Signals Based on Doppler Compensation

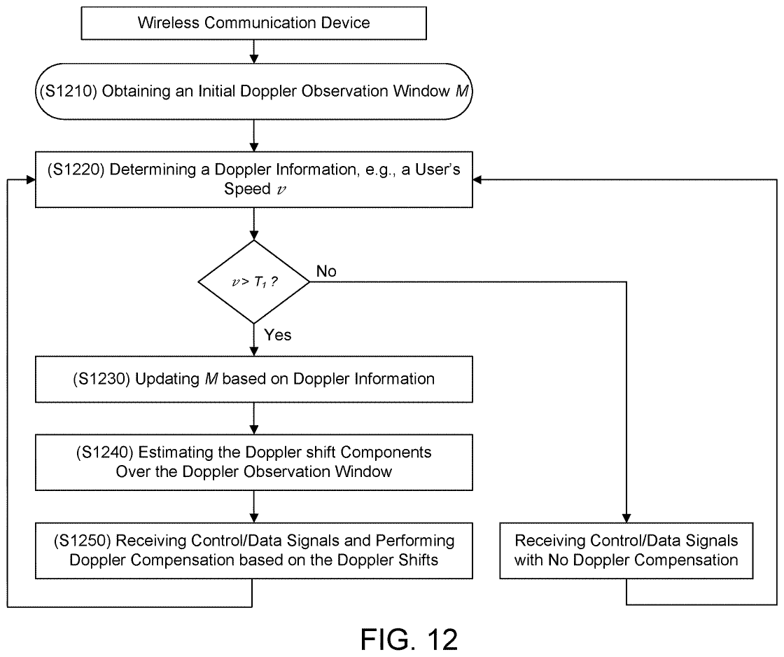

In an exemplary embodiment exemplified in FIG. 12, a first wireless communication device or set of first wireless communication devices receiving wireless signals from a second wireless communication device or set of second wireless communication devices, are characterized by any of the following steps:
(S1210) obtaining an initial duration of a Doppler observation window, e.g., from higher-layer signaling;
(S1220) determining a Doppler information from the second wireless communication device or set of second wireless communication devices, e.g., a user's speed v;
(S1230) updating the Doppler observation window based on the Doppler information, e.g., the user's speed above a first threshold T₁;
(S1240) estimating the Doppler shift components characterizing the signals of the second wireless communication device or set of second wireless communication devices over the duration of the Doppler observation window; and
(S1250) receiving control and data signals from the second wireless communication device or set of second wireless communication devices, and performing Doppler compensation of control and data signals based on the estimated Doppler shift components.

According to embodiments, the first wireless communication device or set of first wireless communication devices may receive signals from the second wireless communication device or set of second wireless communication devices in a multi-TRP with joint reception.

According to embodiments, the threshold T₁ may be pre-configured via higher layer signaling, e.g., through RRC configuration information or System Information.

According to embodiments, the Doppler observation window may comprise a series of time intervals over which one or multiple signals are sent by the second wireless communication device or set of second wireless communication devices for channel state information acquisition, e.g., through SRS or PUSCH DM-RS.

According to embodiments, the initial duration of the Doppler observation window may be individually set for each second wireless communication device or set of second wireless communication devices based on the user's speed.

According to embodiments, the user's speed may be contained in a report sent by the second wireless communication device or set of second wireless communication devices through a shared data channel, e.g., PUSCH.

According to embodiments, the user's speed may be estimated by the first wireless communication device or set of first wireless communication devices by analyzing the time-domain variations of the signals received from the second wireless communication device or set of second wireless communication devices, e.g., SRS or PUSCH DM-RS, in the duration of the Doppler observation window.

According to embodiments, the Doppler shift components may be estimated by the first wireless communication device or set of first wireless communication devices from analysis of the temporal evolution of the beams characterizing the angular-domain channel matrix over the duration of the Doppler observation window.

According to embodiments, the Doppler shift components may be estimated from the signals sent by the second wireless communication device or set of second wireless communication devices for channel state acquisition, e.g., SRS or PUSCH DM-RS.

According to embodiments, the angular-domain channel matrix may be obtained by the first wireless communication device or set of first wireless communication devices through multiplication of a unitary DFT matrix with the time-domain or frequency-domain channel matrix obtained at the radio frequency chains in a multi-antenna system.

According to embodiments, the Doppler compensation operation may involve the point-wise multiplication of the information vector expressed in the angular-domain and a vector containing the complex conjugates of the Doppler shift components estimated at each received beam.

According to embodiments, the Doppler compensation may be applied to the control and data channels, e.g., PUCCH and PUSCH, and to SRS resources aimed for channel state acquisition and not involving speed measurements.

According to embodiments, the first wireless communication device may be a base station and/or the second wireless communication device may be a user equipment (e.g., WTRU) in the uplink of a wireless communication system.

According to embodiments, the first wireless communication device may be a roadside unit and/or the second wireless communication device may be a user equipment (e.g., WTRU) in the sidelink of a wireless communication system.

According to embodiments, the set of first wireless communication devices may be multiple transmit-receive points in the uplink of a multi-TRP Single-Frequency Network (SFN) or joint transmission.

According to embodiments, the second wireless communication device or set of second wireless communication devices may be user equipment (e.g., WTRU) in the uplink or the sidelink of a wireless communication system.

According to embodiments, the wireless links between the first wireless communication device or set of first wireless communication devices and the second wireless communication device or set of second wireless communication devices may be characterized by line-of-sight or non-line of sight conditions with full or partial obstruction of the direct ray.

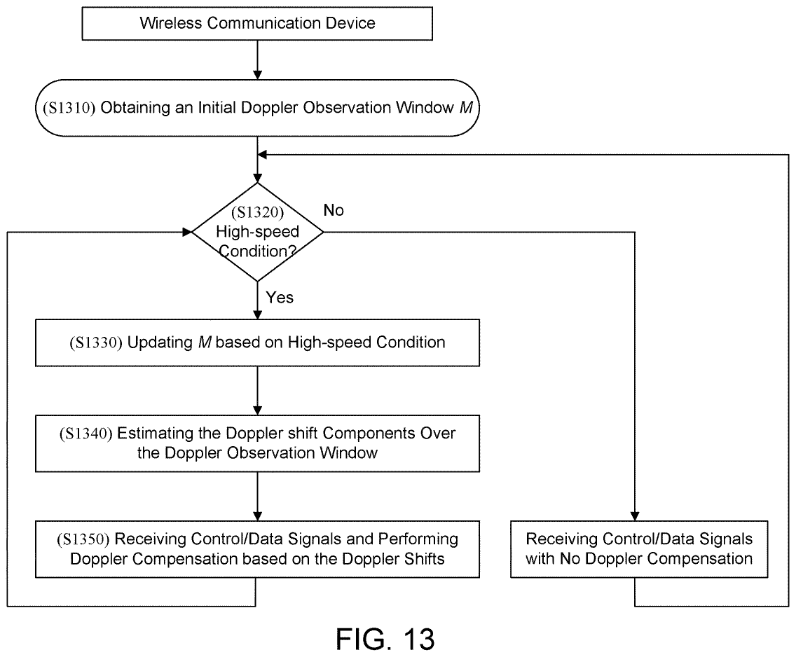

In another exemplary embodiment exemplified in FIG. 13, a first wireless communication device or set of first wireless communication devices receiving wireless signals from a second wireless communication device or set of second wireless communication devices, are characterized by any of the following steps:
(S1310) obtaining an initial duration of a Doppler observation window, e.g., from higher-layer signaling;
(S1320) determining a high-speed condition, e.g., from a high-speed signaling indication from the second wireless communication device or set of second wireless communication devices;
(S1330) updating the Doppler observation window based on said high-speed condition;
(S1340) estimating the Doppler shift components characterizing the signals of the second wireless communication device or set of second wireless communication devices over the duration of the Doppler observation window; and
(S1350) receiving control and data signals from the second wireless communication device or set of second wireless communication devices, and performing Doppler compensation of control and data signals based on the estimated Doppler shift components.

According to embodiments, the first wireless communication device or set of first wireless communication devices may receive signals from the second wireless communication device or set of second wireless communication devices in a multi-TRP with joint reception.

According to embodiments, the Doppler observation window may comprise a series of time intervals over which one or multiple signals are sent by the second wireless communication device or set of second wireless communication devices for channel state information acquisition, e.g., through SRS or PUSCH DM-RS.

According to embodiments, the initial duration of the Doppler observation window may be individually set for each second wireless communication device or set of second wireless communication devices based on the user's speed.

According to embodiments, a high-speed condition may be determined in case the user's speed measured by the first wireless communication device or set of first wireless communication devices exceeds a threshold T₁.

According to embodiments, a high-speed indication may be sent by the second wireless communication device or set of second wireless communication devices in case the user's speed exceeds a threshold T₁.

According to embodiments, the user's speed may be estimated by the first wireless communication device or set of first wireless communication devices by analyzing the time-domain variations of the signals received from the second wireless communication device or set of second wireless communication devices, e.g., SRS or PUSCH DM-RS, in the duration of the Doppler observation window.

According to embodiments, a signaling indication of a threshold T₁ may be sent to the second wireless communication device or set of second wireless communication devices via control information, e.g., DCI, MAC-CE signaling, or RRC configuration information.

According to embodiments, the threshold T₁ may be pre-configured via higher layer signaling, e.g., through RRC configuration information or System Information.

According to embodiments, the Doppler observation window may be increased by a given number of symbols if a high-speed condition is determined by the first wireless communication device or set of first wireless communication devices.

According to embodiments, the Doppler shift components may be estimated by the first wireless communication device or set of first wireless communication devices from analysis of the temporal evolution of the beams characterizing the angular-domain channel matrix over the duration of the Doppler observation window.

According to embodiments, the Doppler shift components may be estimated from the signals sent by the second wireless communication device or set of second wireless communication devices for channel state acquisition, e.g., SRS or PUSCH DM-RS.

According to embodiments, the angular-domain channel matrix may be obtained by the first wireless communication device or set of first wireless communication devices through multiplication of a unitary DFT matrix with the time-domain or frequency-domain channel matrix obtained at the radio frequency chains in a multi-antenna system.

According to embodiments, the Doppler compensation operation may involve the point-wise multiplication of the information vector expressed in the angular-domain and a vector containing the complex conjugates of the Doppler shift components estimated at each received beam.

According to embodiments, the Doppler compensation may be applied to the control and data channels, e.g., PUCCH and PUSCH, and to SRS resources aimed for channel state acquisition and not involving speed measurements.

According to embodiments, the first wireless communication device may be a base station and/or the second wireless communication device is a user equipment (e.g., WTRU) in the uplink of a wireless communication system.

According to embodiments, the first wireless communication device may be a roadside unit and/or the second wireless communication device may be a user equipment (e.g., WTRU) in the sidelink of a wireless communication system.

According to embodiments, the set of first wireless communication devices may be multiple transmit-receive points in the uplink or the sidelink of a multi-TRP Single-Frequency Network (SFN) or joint transmission.

According to embodiments, the second wireless communication device or set of second wireless communication devices may be user equipment (e.g., WTRU) in the uplink of a wireless communication system.

According to embodiments, the wireless links between the first wireless communication device or set of first wireless communication devices and the second wireless communication device or set of second wireless communication devices may be characterized by line-of-sight or non-line of sight conditions with full or partial obstruction of the direct ray.

### Transmission and Reception of Signals by a User Equipment Based on Doppler Information

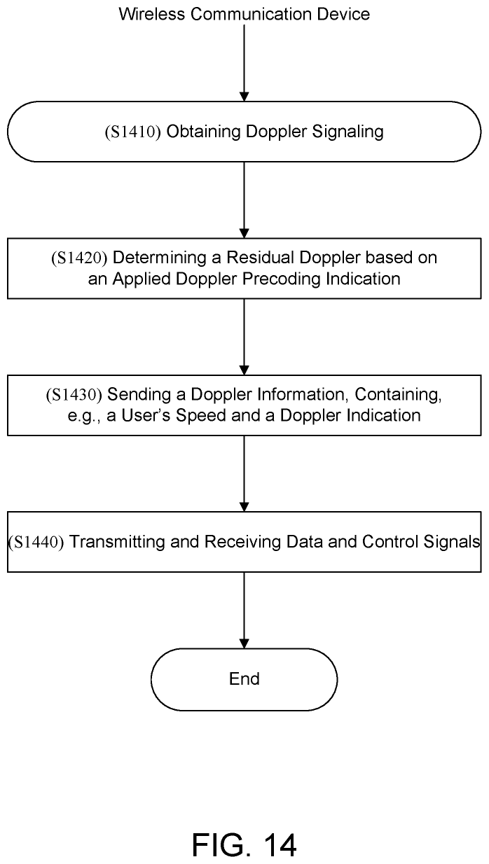

In an exemplary embodiment exemplified in FIG. 14, a first wireless communication device transmitting and receiving wireless signals to a second wireless communication device or set of second wireless communication devices, is characterized by any of the following steps:
(S1410) obtaining a Doppler signaling indication from the second wireless communication device or set of second wireless communication devices containing, e.g., the TRS resource set or a Doppler indication;
(S1420) determining a Doppler on the TRS resource set based on an applied Doppler precoding indication, or the triggering of Doppler measurements and reporting;
(S1430) sending a Doppler information to the second wireless communication device or set of second wireless communication devices containing, e.g., a user's speed or a Doppler indication; and
(S1440) transmitting data and control signals to, and receiving data and control signals from, the second wireless communication device or set of second wireless communication devices.

According to embodiments, the TRS resource set may comprise a set of resource elements in one or several OFDM symbols and one or several physical resource blocks, for reception of TRS signals sent by a second wireless communication device or set of second wireless communication devices.

According to embodiments, the TRS resource set is determined in such a way that no overlap occurs between the resource elements contained in two different TRS resource sets.

According to embodiments, the Doppler signaling indication may comprise a field to notify whether Doppler precoding is applied to the data and the TRS resource set.

According to embodiments, the Doppler signaling indication may comprise a field to trigger the measurement and reporting of Doppler by the first wireless communication device or set of first wireless communication devices.

According to embodiments, the Doppler signaling indication may comprise the value of a threshold T₁ for detection of a high-speed condition, and a threshold T₂ for detection of a high Doppler.

According to embodiments, the Doppler signaling indication may be sent by the second wireless communication device or set of second wireless communication devices via control information, e.g., DCI, MAC-CE signaling, or RRC configuration information.

According to embodiments, the Doppler may be determined by the first wireless communication device if the Doppler signaling indication contains a field indicating the presence of Doppler precoding, or a field to trigger the measurement and reporting of Doppler.

According to embodiments, the Doppler may be measured by the first wireless communication device over the TRS signals contained in the assigned TRS resource set.

According to embodiments, the Doppler indication may be expressed as the amount of Doppler spread, or the rate of variation of the channel state, as measured by the first wireless communication device.

According to embodiments, the Doppler indication may be reported to the second wireless communication device or set of second wireless communication devices through a shared data channel, e.g., PUSCH.

According to embodiments, the Doppler information may comprise an indication of a high-speed condition in case the user's speed exceeds the threshold T₁.

According to embodiments, the Doppler information may comprise an indication of a high Doppler in case the Doppler exceeds the threshold T₂.

According to embodiments, the Doppler information may be sent periodically, aperiodically, in a semi-persistent fashion, based on demand, or upon fulfillment of a given condition or set of conditions.

According to embodiments, the Doppler information may be activated or deactivated based on MAC-CE, or explicitly triggered based on DCI indications.

According to embodiments, the first wireless communication device may be a user equipment (e.g., WTRU) and/or the second wireless communication device is a base station in the uplink of a wireless communication system.

According to embodiments, the first wireless communication device may be a user equipment (e.g., WTRU) and/or the second wireless communication device is a roadside unit in the sidelink of a wireless communication system.

According to embodiments, the set of second wireless communication devices may be multiple transmit-receive points in the uplink of a multi-TRP Single-Frequency Network (SFN) or joint transmission.

According to embodiments, the wireless links between the first wireless communication device or set of first wireless communication devices and the second wireless communication device or set of second wireless communication devices may be characterized by line-of-sight or non-line of sight conditions with full or partial obstruction of the direct ray.

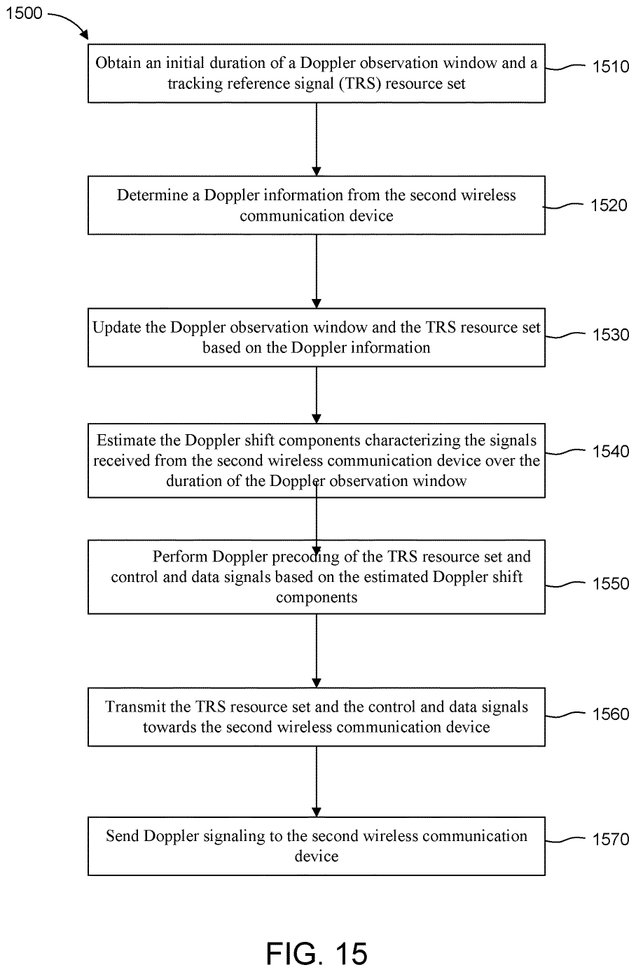

FIG. 15 illustrates an example of a method 1500, implemented by a wireless communication device transmitting signals to a second wireless communication device.

According to embodiments, the wireless communication device may be configured to obtain an initial duration of a Doppler observation window and a TRS resource set (S1510).

According to embodiments, the wireless communication device may be configured to determine a Doppler information from the second wireless communication device (S1520).

According to embodiments, the wireless communication device may be configured to update the Doppler observation window and the TRS resource set based on the Doppler information (S1530).

According to embodiments, the wireless communication device may be configured to estimate the Doppler shift components characterizing the signals received from the second wireless communication device over the duration of the Doppler observation window (S1540).

According to embodiments, the wireless communication device may be configured to perform Doppler precoding of the TRS resource set and control and data signals based on the estimated Doppler shift components (S1550).

According to embodiments, the wireless communication device may be configured to transmit the TRS resource set and the control and data signals towards the second wireless communication device (S1560).

According to embodiments, the wireless communication device may be configured to send Doppler signaling to the second wireless communication device (S1570).

According to embodiments, the Doppler information may comprise a speed of user v and/or a Doppler indication R.

According to embodiments, the Doppler signaling may comprise the TRS resource set and/or a Doppler indication.

According to embodiments, the wireless communication device may be configured to transmit signals to the second wireless communication device in a multi-TRP single-frequency network (SFN) or joint transmission.

According to embodiments, the Doppler observation window may comprise a series of time intervals over which one or multiple signals are sent by the second wireless communication device for channel state information acquisition.

According to embodiments, the TRS resource set may comprise a set of resource elements in one or several OFDM symbols and one or several physical resource blocks, for transmission of TRS signals to the second wireless communication device.

According to embodiments, the TRS resource set may be determined in such a way that no overlap occurs between the resource elements contained in two different TRS resource sets.

According to embodiments, the physical resource elements comprised in the TRS resource set may share the same Doppler precoding operation.

According to embodiments, the speed of the user may be indicated in a report received from the second wireless communication device through a shared data channel.

According to embodiments, the speed of the user may be estimated by analyzing the time-domain variations of the signals received from the second wireless communication device, in the duration of the Doppler observation window.

According to embodiments, the Doppler observation window may be increased by a given number of symbols on condition that the Doppler is higher than a threshold T₂.

According to embodiments, the Doppler shift components may be estimated by the first wireless communication device from analysis of the temporal evolution of the beams characterizing an angular-domain channel matrix over the duration of the Doppler observation window.

According to embodiments, the Doppler shift components may be estimated in a Time-Division Duplex system from the signals sent by the second wireless communication device for channel state acquisition.

According to embodiments, an angular-domain channel matrix may be obtained by the first wireless communication device through multiplication of a unitary DFT matrix with the time-domain or frequency-domain channel matrix obtained at the radio frequency chains in a multi-antenna system.

According to embodiments, the Doppler precoding operation may comprise the multiplication of an angular-domain channel matrix and a vector containing the complex conjugates of the Doppler shift components estimated at each received beam.

According to embodiments, the Doppler precoding operation may comprise non-null entries at the DFT beams selected for MU-MIMO transmission towards the second wireless communication device that are scheduled at the same time-frequency resources.

According to embodiments, the Doppler precoding operation may use a data channel.

According to embodiments, the Doppler precoding operation may use a UE-specific control channel.

According to embodiments, the Doppler precoding operation may use a reference signal for channel estimation and/or demodulation.

According to embodiments, the first wireless communication device may be a base station and/or the second wireless communication device may be a wireless transmit/receive unit (WTRU) in the downlink of a wireless communication system.

According to embodiments, the first wireless communication device may be a roadside unit and/or the second wireless communication device may be a WTRU in the sidelink of a wireless communication system.

According to embodiments, the second wireless communication device may be a WTRU in the downlink or the sidelink of a wireless communication system.

According to embodiments, a wireless link between the first wireless communication device and/or the second wireless communication device may comprise line-of-sight or non-line of sight conditions with full or partial obstruction of the direct ray.

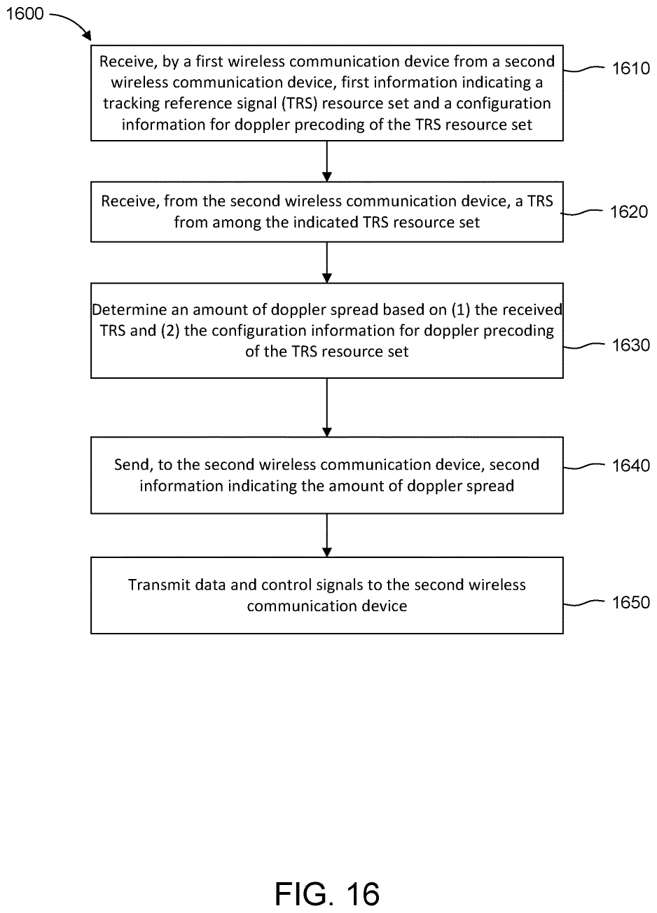

FIG. 16 illustrates an example of a method 1600, implemented by a first wireless communication device.

According to embodiments, the first wireless communication device may be configured to receive, from a second wireless communication device, first information indicating a TRS resource set and configuration information for doppler precoding (e.g., an application of doppler precoding) of the TRS resource set (S1610).

According to embodiments, the first wireless communication device may be configured to receive, from the second wireless communication device, a TRS from among the indicated TRS resource set (S1620).

According to embodiments, the first wireless communication device may be configured to determine an amount of doppler spread based on (1) the received TRS and (2) the configuration information for doppler precoding (e.g., application of doppler precoding) of the TRS resource set; (S1630).

According to embodiments, the first wireless communication device may be configured to send, to the second wireless communication device, second information indicating the amount of doppler spread (S1640).

According to embodiments, the first wireless communication device may be configured to transmit data and control signals to the second wireless communication device (S1650).

According to embodiments, the doppler precoding may be a non-codebook precoding.

According to embodiments, the first wireless communication device may be configured to receive, from the second wireless communication device, a request to determine the amount of doppler spread, and wherein determining an amount of doppler spread over a TRS contained in the TRS resource set is responsive to the request.

According to embodiments, the amount of doppler spread may correspond to a spectral width of a doppler power spectrum of the TRS contained in the TRS resource set.

According to embodiments, the TRS resource set may comprise a set of resource elements in one or several orthogonal frequency-division multiplexing symbols for reception of TRS signals sent by the second wireless communication device.

According to embodiments, the second information may be sent to the second wireless communication device through a shared data channel.

According to embodiments, the first wireless communication device may be configured to determine a speed of the first wireless communication device, and the second information may indicate the speed of the first wireless communication device.

According to embodiments, the second information may indicate a high-speed condition, on condition that the speed is above a first threshold.

According to embodiments, the second information may indicate a high Doppler condition, on condition that the amount of doppler spread is above a second threshold.

According to embodiments, the first wireless communication device may be a WTRU and the second wireless communication device is a base station, a roadside unit, and/or a WTRU.

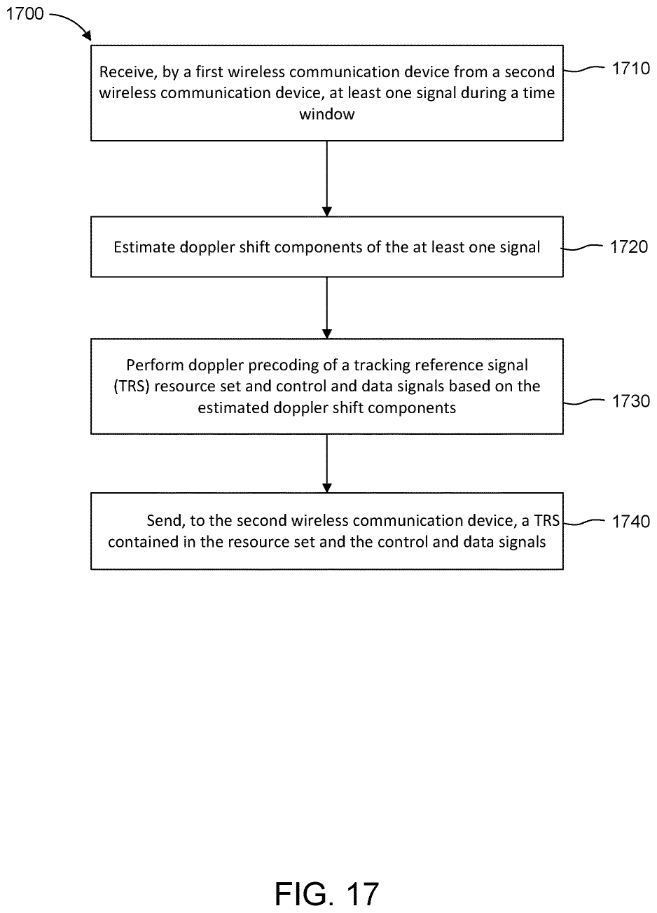

FIG. 17 illustrates an example of a method 1700, implemented by a wireless communication device.

According to embodiments, the first wireless communication device may be configured to receive, from a second wireless communication device, at least one signal during a time window.

According to embodiments, the first wireless communication device may be configured to estimate doppler shift components of the at least one signal.

According to embodiments, the first wireless communication device may be configured to perform doppler precoding of a TRS resource set and control and data signals based on the estimated doppler shift components.

According to embodiments, the first wireless communication device may be configured to send, to the second wireless communication device, a TRS contained in the resource set and the control and data signals.

According to embodiments, the first wireless communication device may be configured to send, to the second wireless communication device, first information indicating an application of doppler precoding to the TRS resource set (e.g., configuration information for doppler precoding of the TRS resource set), and/or indicating the TRS resource set.

According to embodiments, the first wireless communication device may be configured to obtain from the second wireless communication device, second information indicating an amount of doppler spread over the TRS contained in the TRS resource and/or a speed of the second wireless communication device; and may update a length of the time window based on the second information.

According to embodiments, the first wireless communication device may be configured to update the TRS resource set based on the second information.

According to embodiments, the amount of doppler spread may correspond to a spectral width of a doppler power spectrum of the TRS contained in the TRS resource set.

According to embodiments, the first wireless communication device may be configured to transmit signals to the second wireless communication device in a multi-TRP single-frequency network (SFN) or joint transmission.

According to embodiments, the TRS resource set may comprise a set of resource elements in one or several OFDM symbols and one or several physical resource blocks, for transmission of TRS signals to the second wireless communication device.

According to embodiments, obtaining from the second wireless communication device, second information indicating an amount of doppler spread and/or a speed of the second wireless communication device may comprise: receiving, from the second wireless communication device, the second information.

According to embodiments, the second information is received through a shared data channel.

According to embodiments, obtaining from the second wireless communication device, second information indicating a speed of the second wireless communication device may comprise: estimating the speed of the second wireless communication device by analyzing the time-domain variations of the at least one signal received from the second wireless communication device.

According to embodiments, the first wireless communication device may be a base station, a roadside unit, and/or a WTRU and/or the second wireless communication device may be a WTRU.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A method implemented by a first wireless communication device, the method comprising:
receiving, from a second wireless communication device, first information indicating a tracking reference signal (TRS) resource set and a configuration information for doppler precoding of the TRS resource set;
receiving, from the second wireless communication device, a TRS using a TRS resource of the TRS resource set;
determining an amount of doppler spread based on (1) the received TRS and (2) the configuration information for doppler precoding of the TRS resource set; and
sending, to the second wireless communication device, second information indicating the amount of doppler spread.

2. The method according to claim 1, wherein the doppler precoding is a non-codebook precoding.

3. The method according to claim 1, further comprising receiving, from the second wireless communication device, a request to determine the amount of doppler spread, and wherein determining an amount of doppler spread over a TRS contained in the TRS resource set is responsive to the request.

4. The method according to claim 1, wherein the amount of doppler spread corresponds to a spectral width of a doppler power spectrum of the TRS contained in the TRS resource set.

5. The method according to claim 1, wherein the TRS resource set comprises a set of resource elements in one or several orthogonal frequency-division multiplexing symbols for reception of TRS signals sent by the second wireless communication device.

6. The method according to claim 1, wherein the second information is sent to the second wireless communication device through a shared data channel.

7. The method according to claim 1, further comprising determining a speed of the first wireless communication device, and wherein the second information further indicates the speed of the first wireless communication device.

8. The method according to claim 7, wherein the second information further indicates a high-speed condition, on condition that the speed is above a first threshold.

9. The method according to claim 1, wherein the second information further indicates a high Doppler condition, on condition that the amount of doppler spread is above a second threshold.

10. The method according to claim 1, wherein the first wireless communication device is a wireless transmit/receive unit (WTRU) and the second wireless communication device is a base station, a roadside unit, and/or a WTRU.

11. A first wireless communication device comprising circuitry, including a transmitter, a receiver, a processor and memory, the first wireless communication device configured to:
receive, from a second wireless communication device, first information indicating a tracking reference signal (TRS) resource set and a configuration information for doppler precoding of the TRS resource set;
receive, from the second wireless communication device, a TRS using a TRS resource of TRS resource set;
determine an amount of doppler spread based on (1) the received TRS and (2) the configuration information for doppler precoding of the TRS resource set; and
send, to the second wireless communication device, second information indicating the amount of doppler spread.

12. The first wireless communication device according to claim 11, wherein the doppler precoding is a non-codebook precoding.

13. The first wireless communication device according to claim 11, configured to receive, from the second wireless communication device, a request to determine the amount of doppler spread, and wherein determining an amount of doppler spread over a TRS contained in the TRS resource set is responsive to the request.

14. The first wireless communication device according to claim 11, wherein the amount of doppler spread corresponds to a spectral width of a doppler power spectrum of the TRS contained in the TRS resource set.

15. The first wireless communication device according to claim 11, wherein the TRS resource set comprises a set of resource elements in one or several orthogonal frequency-division multiplexing symbols for reception of TRS signals sent by the second wireless communication device.

16. The first wireless communication device according to claim 11, wherein the second information is sent to the second wireless communication device through a shared data channel.

17. first wireless communication device according to claim 11, configured to determine a speed of the first wireless communication device, and wherein the second information further indicates the speed of the first wireless communication device.

18. The first wireless communication device according to claim 17, wherein the second information further indicates a high-speed condition, on condition that the speed is above a first threshold.

19. The first wireless communication device according to claim 11, wherein the second information further indicates a high Doppler condition, on condition that the amount of doppler spread is above a second threshold.

20. The first wireless communication device according to claim 11, wherein the first wireless communication device is a wireless transmit/receive unit (WTRU) and the second wireless communication device is a base station, a roadside unit, and/or a WTRU.
